(19) United States
(12) Patent Application Publication
(10) Pub. No.: US 2023/0095560 A1
(43) Pub. Date: Mar. 30, 2023

(54) WIRELESS COMMUNICATION DEVICE SYNCHRONIZATION

(71) Applicant: QUALCOMM Incorporated, San Diego, CA (US)

(72) Inventors: Stelios STEFANATOS, San Diego, CA (US); Shuanshuan WU, San Diego, CA (US); Arthur GUBESKYS, San Diego, CA (US)

(21) Appl. No.: 17/905,014

(22) PCT Filed: Apr. 23, 2021
(86) PCT No.: PCT/US2021/028953

§ 371 Date: Aug. 25, 2022

(30) Foreign Application Priority Data
Apr. 27, 2020 (GR) 20200100213

(51) Int. Cl. H04W 74/08; H04W 56/00

(52) U.S. Cl. CPC H04W 74/0808; H04W 56/0015

(57) ABSTRACT

Certain aspects of the present disclosure provide techniques for sidelink communications in an unlicensed spectrum. A method that may be performed by a device includes sensing a channel for interference in each of a plurality of time intervals in order of time until interference below a threshold is sensed for one of the plurality of time intervals or interference above the threshold is sensed for all of the plurality of time intervals, the plurality of time intervals being of a time window. The method may also include sensing interference to be above a threshold in a first portion of the one of the plurality of time intervals. The method may also include sensing interference to be below the threshold in a second portion of the one of the plurality of time intervals that occurs later in time than the first portion.

### CROSS-REFERENCE TO RELATED APPLICATION(S)

This application claims benefit of and priority to Greek Patent Application No. 20200100213, filed Apr. 27, 2020, which is hereby assigned to the assignee hereof and hereby expressly incorporated by reference herein in its entirety as if fully set forth below and for all applicable purposes.

### INTRODUCTION

Aspects of the present disclosure relate to wireless communications, and more particularly, to techniques for synchronization of wireless communication devices.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide improved techniques for synchronization of wireless communication devices, such as those communicating in one or more unlicensed frequency bands.

Certain aspects of the subject matter described in this disclosure can be implemented in a device for wireless communication. The device generally includes a memory and a processor coupled to the memory. The processor and memory are configured to sense a channel for interference in each of a plurality of time intervals in order of time until interference below a threshold is sensed for one of the plurality of time intervals or interference above the threshold is sensed for all of the plurality of time intervals, the plurality of time intervals forming a time window. The processor and memory are also configured to sense interference to be above a threshold in a first portion of the one of the plurality of time intervals. The processor and memory are also configured to sense interference to be below the threshold in a second portion of the one of the plurality of time intervals that occurs later in time than the first portion. The processor and memory are also configured to transmit one of a reservation signal or a portion of a synchronization signal (SS) corresponding to the second portion in the second portion of the one plurality of time intervals.

Certain aspects of the subject matter described in this disclosure can be implemented in a device for wireless communication. The device generally includes a memory and a processor coupled to the memory. The processor and memory are configured to communicate a size of a time window, wherein the time window comprises a plurality of time intervals, the size of the time window based at least in part on a number of previous time intervals during which interference above a threshold was sensed. The processor and memory are also configured to sense a channel for interference in each of the plurality of time intervals in order of time until interference below the threshold is sensed for one of the plurality of time intervals or interference above the threshold is sensed for all of the plurality of time intervals. The processor and memory are also configured to, when interference below the threshold is sensed for the one of the plurality of time intervals, transmit a synchronization signal (SS) in the one of the plurality of time intervals. The processor and memory are also configured to, when interference above the threshold is sensed for all of the plurality of time intervals, refrain from transmitting the SS in the time window.

Certain aspects of the subject matter described in this disclosure can be implemented in a method for wireless communication by a device. The method generally includes sensing a channel for interference in each of a plurality of time intervals in order of time until interference below a threshold is sensed for one of the plurality of time intervals or interference above the threshold is sensed for all of the plurality of time intervals, the plurality of time intervals forming a time window. The method also includes sensing interference to be above a threshold in a first portion of the one of the plurality of time intervals. The method also includes sensing interference to be below the threshold in a second portion of the one of the plurality of time intervals that occurs later in time than the first portion. The method also includes transmitting one of a reservation signal or a portion of a synchronization signal (SS) corresponding to the second portion in the second portion of the one plurality of time intervals.

Certain aspects of the subject matter described in this disclosure can be implemented in a method for wireless communication by a device. The method generally includes communicating a size of a time window, wherein the time window comprises a plurality of time intervals, the size of the time window based at least in part on a number of previous time intervals during which interference above a threshold was sensed. The method also includes sensing a channel for interference in each of the plurality of time intervals in order of time until interference below the threshold is sensed for one of the plurality of time intervals or interference above the threshold is sensed for all of the plurality of time intervals. The method also includes, when interference below the threshold is sensed for the one of the plurality of time intervals, transmitting a synchronization signal (SS) in the one of the plurality of time intervals. The method also includes, when interference above the threshold is sensed for all of the plurality of time intervals, refraining from transmitting the SS in the time window.

Certain aspects of the subject matter described in this disclosure can be implemented by a device for wireless communication. The device generally includes means for sensing a channel for interference in each of a plurality of time intervals in order of time until interference below a threshold is sensed for one of the plurality of time intervals or interference above the threshold is sensed for all of the plurality of time intervals, the plurality of time intervals forming a time window. The device also includes means for sensing interference to be above a threshold in a first portion of the one of the plurality of time intervals. The device also includes means for sensing interference to be below the threshold in a second portion of the one of the plurality of time intervals that occurs later in time than the first portion. The device also includes means for transmitting one of a reservation signal or a portion of a synchronization signal (SS) corresponding to the second portion in the second portion of the one of the plurality of time intervals.

Certain aspects of the subject matter described in this disclosure can be implemented by a device for wireless communication. The device generally includes means for communicating a size of a time window, wherein the time window comprises a plurality of time intervals, the size of the time window based at least in part on a number of previous time intervals during which interference above a threshold was sensed. The device also includes means for sensing a channel for interference in each of the plurality of time intervals in order of time until interference below the threshold is sensed for one of the plurality of time intervals or interference above the threshold is sensed for all of the plurality of time intervals. The device also includes, when interference below the threshold is sensed for the one of the plurality of time intervals, means for transmitting a synchronization signal (SS) in the one of the plurality of time intervals. The device also includes, when interference above the threshold is sensed for all of the plurality of time intervals, means for refraining from transmitting the SS in the time window.

Certain aspects of the subject matter described in this disclosure can be implemented by a non-transitory computer-readable medium having instructions stored thereon that, when executed by a device, cause the device to perform operations for wireless communication comprising sensing a channel for interference in each of a plurality of time intervals in order of time until interference below a threshold is sensed for one of the plurality of time intervals or interference above the threshold is sensed for all of the plurality of time intervals, the plurality of time intervals forming a time window. The operations also include sensing interference to be above a threshold in a first portion of the one of the plurality of time intervals. The operations also include sensing interference to be below the threshold in a second portion of the one of the plurality of time intervals that occurs later in time than the first portion. The operations also include transmitting one of a reservation signal or a portion of a synchronization signal (SS) corresponding to the second portion in the second portion of the one plurality of time intervals.

Certain aspects of the subject matter described in this disclosure can be implemented by a non-transitory computer-readable medium having instructions stored thereon that, when executed by a device, cause the device to perform operations for wireless communication comprising communicating a size of a time window, wherein the time window comprises a plurality of time intervals, the size of the time window based at least in part on a number of previous time intervals during which interference above a threshold was sensed. The operations also include sensing a channel for interference in each of the plurality of time intervals in order of time until interference below the threshold is sensed for one of the plurality of time intervals or interference above the threshold is sensed for all of the plurality of time intervals. The operations also include, when interference below the threshold is sensed for the one of the plurality of time intervals, transmitting a synchronization signal (SS) in the one of the plurality of time intervals. The operations also include, when interference above the threshold is sensed for all of the plurality of time intervals, refraining from transmitting the SS in the time window.

Certain aspects of the subject matter described in this disclosure can be implemented in a method for wireless communication by a user equipment (UE). The method generally includes sensing a channel for interference for a plurality of time intervals in order of time until no interference is found for one of the plurality of time intervals or interference is found for all of the plurality of time intervals, the plurality of time intervals forming a time window. In some aspects, the method includes, when no interference is found for the one of the plurality of time intervals, transmitting a synchronization signal (SS) in the one of the plurality of time intervals. In some aspects, the method includes, when interference is found for all of the plurality of time intervals, refraining from transmitting the SS in the time window.

Certain aspects of the subject matter described in this disclosure can be implemented in a user equipment (UE) configured for wireless communication. The apparatus generally includes a processor, and a memory coupled to the processor. In some examples, the processor and the memory may be configured to sense a channel for interference for a plurality of time intervals in order of time until no interference is found for one of the plurality of time intervals or interference is found for all of the plurality of time intervals. In some examples, when no interference is found for the one of the plurality of time intervals, the processor and the memory may be configured to transmit a synchronization signal (SS) in the one of the plurality of time intervals. In some examples, when interference is found for all of the plurality of time intervals, the processor and the memory may be configured to refrain from transmitting the SS in the time window.

Certain aspects of the subject matter described in this disclosure can be implemented in an apparatus configured for wireless communication. In some examples, the apparatus may include means for sensing a channel for interference for a plurality of time intervals in order of time until no interference is found for one of the plurality of time intervals or interference is found for all of the plurality of time intervals, the plurality of time intervals forming a time window. In some examples, the apparatus may include means for transmitting a synchronization signal (SS) in the one of the plurality of time intervals when no interference is found for the one of the plurality of time intervals. In some examples, the apparatus may include means for refraining from transmitting the SS in the time window when interference is found for all of the plurality of time intervals.

Certain aspects of the subject matter described in this disclosure can be implemented in non-transitory computer-readable storage medium having instructions stored thereon for performing a method of wireless communication. In some examples, the method includes sensing a channel for interference for a plurality of time intervals in order of time until no interference is found for one of the plurality of time intervals or interference is found for all of the plurality of time intervals, the plurality of time intervals forming a time window. In some examples, when no interference is found for the one of the plurality of time intervals, the method includes transmitting a synchronization signal (SS) in the one of the plurality of time intervals. In some examples, when interference is found for all of the plurality of time intervals, the method includes refraining from transmitting the SS in the time window.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example base station (BS) and user equipment (UE), in accordance with certain aspects of the present disclosure.

FIG. 3 is a diagram conceptually illustrating an example of a first UE communicating with one or more other UEs, according to aspects of the present disclosure.

FIG. 4 is a diagram illustrating an example frame format, in accordance with certain aspects of the present disclosure.

FIG. 5 is a diagram conceptually illustrating an example cellular vehicle-to-everything (CV2X) network, according to aspects of the present disclosure

FIG. 6 is a block diagram illustrating example slots in a frequency channel, in accordance with certain aspects of the present disclosure.

FIG. 7 is a block diagram illustrating example slots in a frequency channel, in accordance with certain aspects of the present disclosure.

FIG. 8 is a block diagram illustrating example slots in a frequency channel, in accordance with certain aspects of the present disclosure.

FIG. 9 is a flow diagram illustrating example operations for wireless communication, in accordance with certain aspects of the present disclosure.

FIG. 10 illustrates a communications device that may include various components configured to perform operations for the techniques disclosed herein in accordance with aspects of the present disclosure.

FIG. 11 is a flow diagram illustrating example operations for wireless communication, in accordance with certain aspects of the present disclosure.

FIG. 12 illustrates a communications device that may include various components configured to perform operations for the techniques disclosed herein in accordance with aspects of the present disclosure.

FIG. 13 is a flow diagram illustrating example operations for wireless communication, in accordance with certain aspects of the present disclosure.

FIG. 14 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be utilized on other aspects without specific recitation.

### DETAILED DESCRIPTION

Aspects of the present disclosure provide apparatus, methods, processing systems, and computer readable mediums for synchronization between wireless communication devices (e.g., user equipment, base station, etc.). In certain aspects, the techniques described are applicable to synchronization between wireless communication devices operating in an unlicensed spectrum. In certain aspects, the techniques described are applicable to synchronization between wireless communication devices communicating over a sidelink, such as in vehicle to everything (V2X) networks. It should be noted that though certain aspects are described with respect to use for sidelink communication in an unlicensed spectrum, such aspects may be applicable in other suitable wireless communication networks and/or scenarios.

In certain aspects, the following disclosure is directed to techniques for communicating synchronization signaling between wireless communication devices. Wireless communication between devices may require synchronization of signaling between the devices. For example, the devices may periodically broadcast synchronization signaling that other devices can use to find, synchronize to, and use to identify other devices. However, broadcasted synchronization signaling may cause interference with other signals being communicated over the same frequency channel.

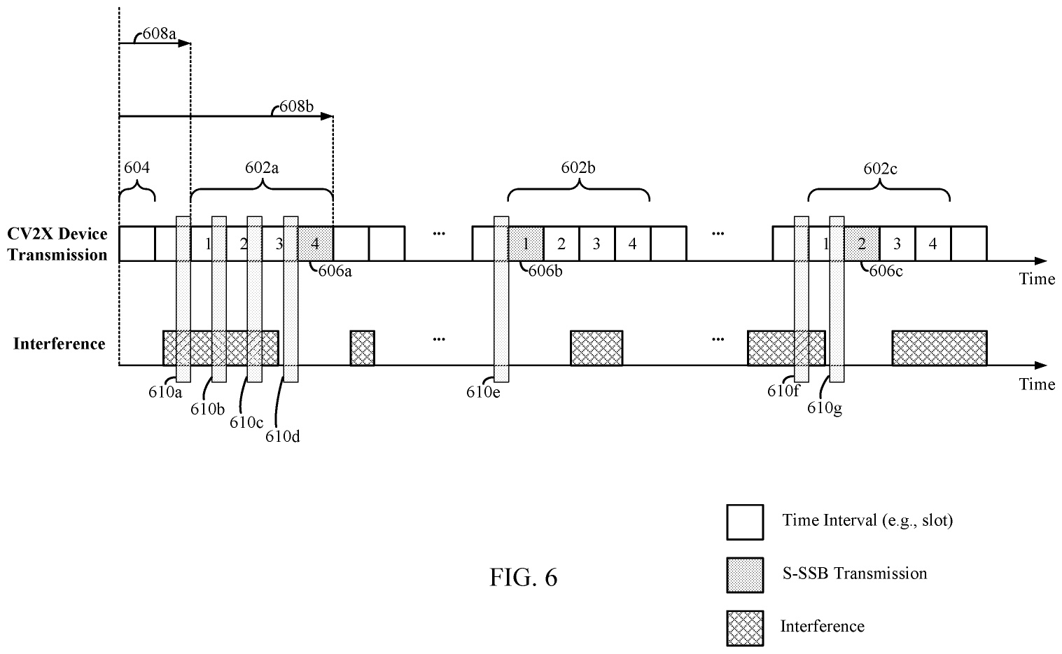

Thus, in some examples, a wireless communication device may be configured to perform a listen-before-talk (LBT) channel sensing procedure prior to broadcasting a synchronization signal to first determine whether the frequency channel has too much interference from other signaling. In certain aspects, the wireless communication device may receive information (e.g., from another wireless communication device, such as a base station (BS), a core network (CN) node, or a user equipment (UE)) about a location and duration of a window of time (e.g., a duration of time within a frame comprising a plurality of slots) for transmitting a synchronization signal. The information may indicate a start of the window (e.g., an offset from a start of a frame in terms of, for example, one or more of a frame index and a slot index, or other suitable identifier/metric), a periodic interval of the window, a transmission time interval (TTI) of the window, etc.). The wireless communication device may then perform LBT channel sensing immediately prior to the start of the window, and in some cases, one or more times within the window, to sense an amount of interference on the frequency channel before and/or during the window, as illustrated in FIGS. 6-8 and described in more detail below. This provides the wireless communication device with the ability to opportunistically broadcast synchronization signals during portions of the window where little or no interference is detected.

In certain aspects, LBT channel sensing is performed to determine whether interfering signals exist on a frequency channel over which the wireless communication device is to transmit a synchronization signal. In one example, the wireless communication device performs LBT channel sensing immediately prior to a first slot of the window to determine whether interfering signals exist on the frequency channel. If the frequency channel is idle, the wireless communication device may transmit a synchronization signal over the first slot in the window. If interference is detected on the frequency channel, the wireless communication device may perform LBT channel sensing again immediately prior to a second slot of the window. The wireless communication device may continue to perform LBT channel sensing in a chronological order of the slots in the window until interference is not sensed.

If the frequency channel is determined to be idle prior to transmission of a synchronization signal, the risk of collision or path loss is reduced because an idle channel indicates that there are no other signals on the frequency channel to interfere with the synchronization signal. Moreover, the likelihood of encountering an idle period on the frequency channel is increased by establishing a window having multiple slots for transmission of synchronization signals. In an example where the wireless communication device transmits synchronization signals over a frequency channel in an unlicensed spectrum, the techniques described herein provide methods of communication aligned with regulations for fair use of the unlicensed spectrum (e.g., by not overcrowding the frequency channel with signaling that could interfere with other devices). By aligning communication practices with fair use regulations, such communications can be operated on an unlicensed spectrum. Thus, due to licensed spectrum scarcity, the transmission of synchronization signaling, among others, can be migrated to an unlicensed spectrum.

Techniques discussed herein allow for the synchronization of devices communicating in the unlicensed band without causing interference to other devices operating in the unlicensed band, thereby enhancing device coexistence. Further, techniques herein allow for such synchronization between devices when satellite based synchronization techniques are unavailable, thereby enhancing access to the unlicensed band/medium. Such techniques also account for potential unavailability of the unlicensed band due to communication by other devices, such as through the use of LBT and a time window for transmitting synchronization signals as discussed herein. Accordingly, the techniques herein lead to improved reliability of a synchronization procedure in unlicensed spectrum, such that a synchronization signal is more likely to be transmitted when expected and properly decoded. Thus, these techniques can help improve latency, by reducing the time devices have to wait to achieve synchronization. These techniques can further improve data decoding reliability, by allowing devices to be synchronized more quickly and thus be able to decode transmissions.

Such techniques may be used, for example, in sidelink communications between wireless communication devices. In other examples, the wireless communication devices may include cellular vehicle-to-everything (CV2X) devices.

The following description provides examples of techniques for synchronization between wireless communication devices, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method, which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 megahertz (MHz) or beyond), millimeter wave (mmW) targeting high carrier frequency (e.g., 25 gigahertz (GHz) or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

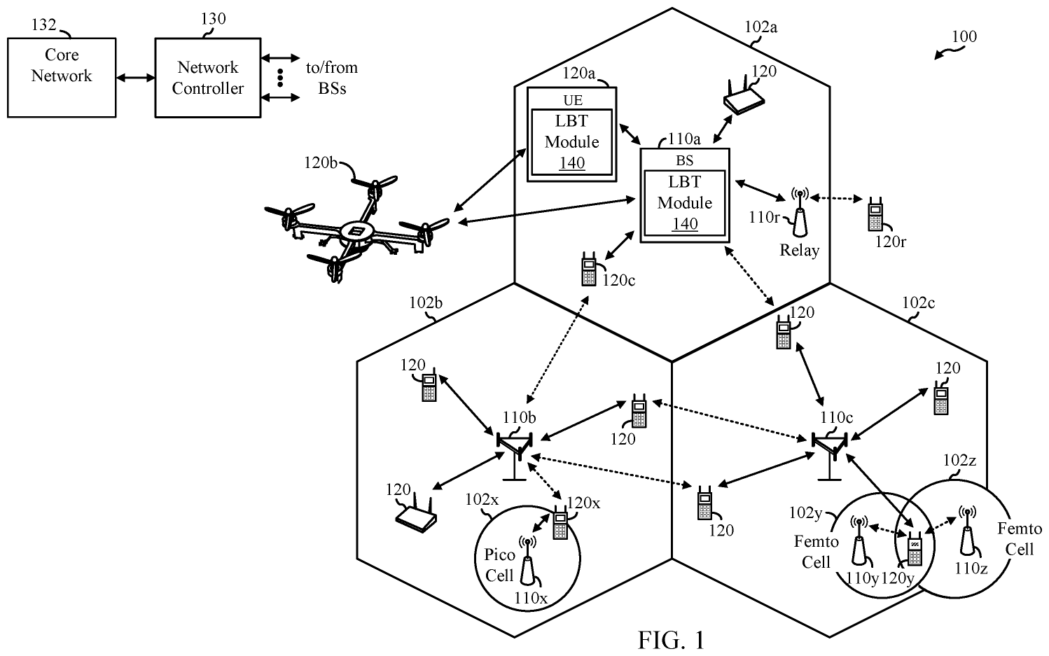

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. A network controller 130 may couple to a set of BSs 110 and provide coordination and control for these BSs 110 (e.g., via a backhaul).

The BSs 110 communicate with UEs 120a-y (each also individually referred to herein as UE 120 or collectively as UEs 120) in the wireless communication network 100. The UEs 120 (e.g., 120d, 120x, 120y, etc.) may be dispersed throughout the wireless communication network 100, and each UE 120 may be stationary or mobile. In one example, a quadcopter, drone, or any other unmanned aerial vehicle (UAV) or remotely piloted aerial system (RPAS) 120d may be configured to function as a UE. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

In some examples of the wireless communication network 100, sidelink communication may be established between UEs and/or BSs without necessarily relying on UE ID or control information from a base station. For example, UE 120a may initiate a sidelink communication with UE 120b without relying on a direct connection with a base station (e.g., base station 110a), such as if the UE 120b is outside of cell 102a's range. Any of the UEs illustrated in FIG. 1 may function as a scheduling entity or a primary sidelink device, while the other UEs may function as a subordinate entity or a non-primary (e.g., secondary) sidelink device. Further, the UEs may be configured to transmit synchronization signaling for sidelink as described throughout the disclosure. Accordingly, one or more of the UEs may function as a scheduling entity in a device-to-device (D2D), peer-to-peer (P2P), or vehicle-to-vehicle (V2V) network, and/or in a mesh network to initiate and/or schedule synchronization signaling.

According to certain aspects, the BSs 110 and UEs 120 may be configured for transmitting synchronization signals over a wireless interface, such as in one or more unlicensed frequency bands. As shown in FIG. 1, the BS 110a includes a listen-before-talk (LBT) module 140. The LBT module 140 may be configured to sense a channel for interference for a plurality of time intervals in order of time until no interference is found for one of the plurality of time intervals or interference is found for all of the plurality of time intervals, the plurality of time intervals forming a time window. In some examples, the time window may provide timing resources for transmitting a synchronization signal (SS).

The LBT module 140 may also be configured to transmit the SS in the one of the plurality of time intervals when no interference is found for the one of the plurality of time intervals, and refrain from transmitting the SS in the time window when interference is found for all of the plurality of time intervals, in accordance with aspects of the present disclosure.

As shown in FIG. 1, the UE 120a includes an LBT module 140. Similar to the BS 110a, the LBT module 140 of the UE 120a may be configured to sense a channel for interference for a plurality of time intervals in order of time until no interference is found for one of the plurality of time intervals or interference is found for all of the plurality of time intervals, the plurality of time intervals forming a time window. In some examples, the time window may provide timing resources for transmitting a synchronization signal (SS).

The LBT module 140 may also be configured to transmit the SS in the one of the plurality of time intervals when no interference is found for the one of the plurality of time intervals, and refrain from transmitting the SS in the time window when interference is found for all of the plurality of time intervals, in accordance with aspects of the present disclosure.

In certain aspects, the LBT module 140 may be configured to sense a frequency channel for interference in each of a plurality of time intervals (e.g., a plurality of slots) in order of time until interference below a threshold is sensed for one of the plurality of time intervals or interference above the threshold is sensed for all of the plurality of time intervals, the plurality of time intervals forming a time window for transmitting a synchronization signal (SS). The LBT module 140 may also be configured to sense interference to be above a threshold in a first portion (e.g., less than all of the symbols in a slot) of the one of the plurality of time intervals. The LBT module may also 140 be configured to sense interference to be below the threshold in a second portion of the one of the plurality of time intervals that occurs later in time than the first portion. The LBT module 140 may also be configured to transmit one of a reservation signal or a portion of the SS corresponding to the second portion in the second portion of the one of the plurality of time intervals.

In certain aspects, the LBT module 140 may be configured to communicate a size of a time window, wherein the time window comprises a plurality of time intervals, the size of the time window based at least in part on a number of previous time intervals during which interference above a threshold was sensed. The LBT module 140 may also be configured to sense a channel for interference in each of the plurality of time intervals in order of time until interference below the threshold is sensed for one of the plurality of time intervals or interference above the threshold is sensed for all of the plurality of time intervals. The LBT module 140 may also be configured to, when interference below the threshold is sensed for the one of the plurality of time intervals, transmit a synchronization signal (SS) in the one of the plurality of time intervals. The LBT module 140 may also be configured to, when interference above the threshold is sensed for all of the plurality of time intervals, refrain from transmitting the SS in the time window.

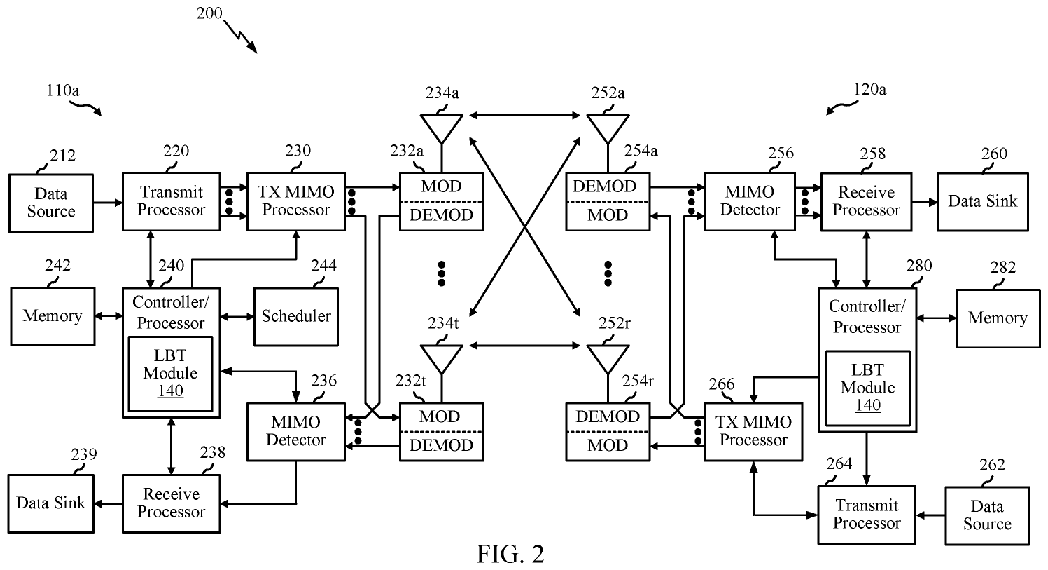

FIG. 2 illustrates example components 200 of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid automatic repeat request (HARD) indicator channel (PHICH), physical downlink control channel (PDCCH), group common (GC) PDCCH, etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has an LBT module 140 that may be configured to sense a channel for interference for a plurality of time intervals in order of time until no interference is found for one of the plurality of time intervals or interference is found for all of the plurality of time intervals, the plurality of time intervals forming a time window for transmitting a synchronization signal (SS).

The LBT module 140 may also be configured to transmit the SS in the one of the plurality of time intervals when no interference is found for the one of the plurality of time intervals, and refrain from transmitting the SS in the time window when interference is found for all of the plurality of time intervals, in accordance with aspects of the present disclosure.

In certain aspects, the LBT module 140 may be configured to sense a frequency channel for interference in each of a plurality of time intervals (e.g., a plurality of slots) in order of time until interference below a threshold is sensed for one of the plurality of time intervals or interference above the threshold is sensed for all of the plurality of time intervals, the plurality of time intervals forming a time window. In some examples, the time window may provide timing resources for transmitting a synchronization signal (SS). The LBT module 140 may also be configured to sense interference to be above a threshold in a first portion (e.g., less than all of the symbols in a slot) of the one of the plurality of time intervals. The LBT module may also 140 be configured to sense interference to be below the threshold in a second portion of the one of the plurality of time intervals that occurs later in time than the first portion. The LBT module 140 may also be configured to transmit one of a reservation signal or a portion of the SS corresponding to the second portion in the second portion of the one of the plurality of time intervals.

In certain aspects, the LBT module 140 may be configured to communicate a size of a time window, wherein the time window comprises a plurality of time intervals, the size of the time window based at least in part on a number of previous time intervals during which interference above a threshold was sensed. The LBT module 140 may also be configured to sense a channel for interference in each of the plurality of time intervals in order of time until interference below the threshold is sensed for one of the plurality of time intervals or interference above the threshold is sensed for all of the plurality of time intervals. The LBT module 140 may also be configured to, when interference below the threshold is sensed for the one of the plurality of time intervals, transmit a synchronization signal (SS) in the one of the plurality of time intervals. The LBT module 140 may also be configured to, when interference above the threshold is sensed for all of the plurality of time intervals, refrain from transmitting the SS in the time window.

As shown in FIG. 2, the controller/processor 280 of the UE 120a also has an LBT module 140 that may be configured to sense a channel for interference for a plurality of time intervals in order of time until no interference is found for one of the plurality of time intervals or interference is found for all of the plurality of time intervals, the plurality of time intervals forming a time window. In some examples, the time window may provide timing resources for transmitting a synchronization signal (SS).

The LBT module 140 may also be configured to transmit the SS in the one of the plurality of time intervals when no interference is found for the one of the plurality of time intervals, and refrain from transmitting the SS in the time window when interference is found for all of the plurality of time intervals, in accordance with aspects of the present disclosure. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 kilohertz (kHz) and other SCS may be defined with respect to the base SCS (e.g., 30 kHz, 60 kHz, 120 kHz, 240 kHz, etc.).

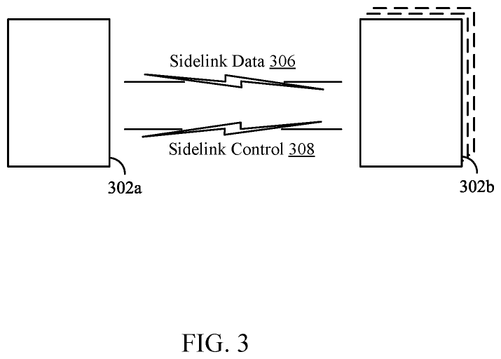

FIG. 3 is a diagram conceptually illustrating a sidelink communication between a first UE 302a and one or more second UEs 302b (collectively, “second UE 302b”). In various examples, any one of the first UE 302a and the second UE 302b may correspond to a UE (e.g., UE 120a, UE 120b, or UE 120c of FIG. 1) or other suitable node in the wireless communication network 100. Although not shown in the illustration, it is contemplated that the one or more second UEs 302b may alternatively be one or more BSs (e.g., BS 110a of FIG. 1).

In some examples, the first UE 302a and the second UE 302b may utilize sidelink signals for direct D2D communication. The D2D communication may use the downlink/uplink wireless wide area network (WWAN) spectrum and/or an unlicensed spectrum. The D2D communication may use one or more sidelink channels, such as a physical sidelink broadcast channel (PSBCH), a physical sidelink discovery channel (PSDCH), a physical sidelink shared channel (PSSCH), and a physical sidelink control channel (PSCCH) over these spectrums. D2D communication may be through a variety of wireless D2D communications systems, such as for example, FlashLinQ, WiMedia, Bluetooth, ZigBee, Wi-Fi based on the Institute of Electrical and Electronics Engineers (IEEE) 802.11 standard, LTE, or NR.

Sidelink signals may include sidelink data 306 (i.e., sidelink traffic) and sidelink control information 308. Broadly, the first UE 302a and one or more second UEs 302b may communicate sidelink data 306 and sidelink control information 308 using one or more data channels and control channels. In some aspects, data channels include the PSSCH, and control channels include the PSCCH and/or physical sidelink feedback channel (PSFCH).

Sidelink control information 308 may include a source transmit signal (STS), a direction selection signal (DSS), and a destination receive signal (DRS). The DSS or STS may provide for a UE 302 (e.g., 302a, 302b) to request a duration of time to keep a sidelink channel available for a sidelink signal; and the DRS may provide for the UE 302 to indicate the availability of the sidelink channel, e.g., for a requested duration of time. Accordingly, the first UE 302a and the second UE 302b may negotiate the availability and use of sidelink channel resources prior to communication of sidelink data 306 information.

In some configurations, any one or more of the first UE 302a or the second UE 302b may periodically/aperiodically transmit or broadcast sidelink synchronization signaling to increase chances of detection by another UE or BS. For example, one or more of the first UE 302a and the second UE 302b may periodically/aperiodically transmit sidelink synchronization signals in one or more slots of specific time windows. In some examples, the UEs are preconfigured with information indicating the location and duration of the time window within a frame (e.g., which slots within the frame, and how many). In some aspects, the UEs may be configured with the location and duration of the time window via messaging between UEs or messaging received from a BS (e.g., RRC signaling).

The channels or carriers illustrated in FIG. 3 are not necessarily all of the channels or carriers that may be utilized between a first UE 302a and a second UE 302b in a sidelink communication, and those of ordinary skill in the art will recognize that other channels or carriers may be utilized in addition to those illustrated, such as other data, control, and feedback channels.

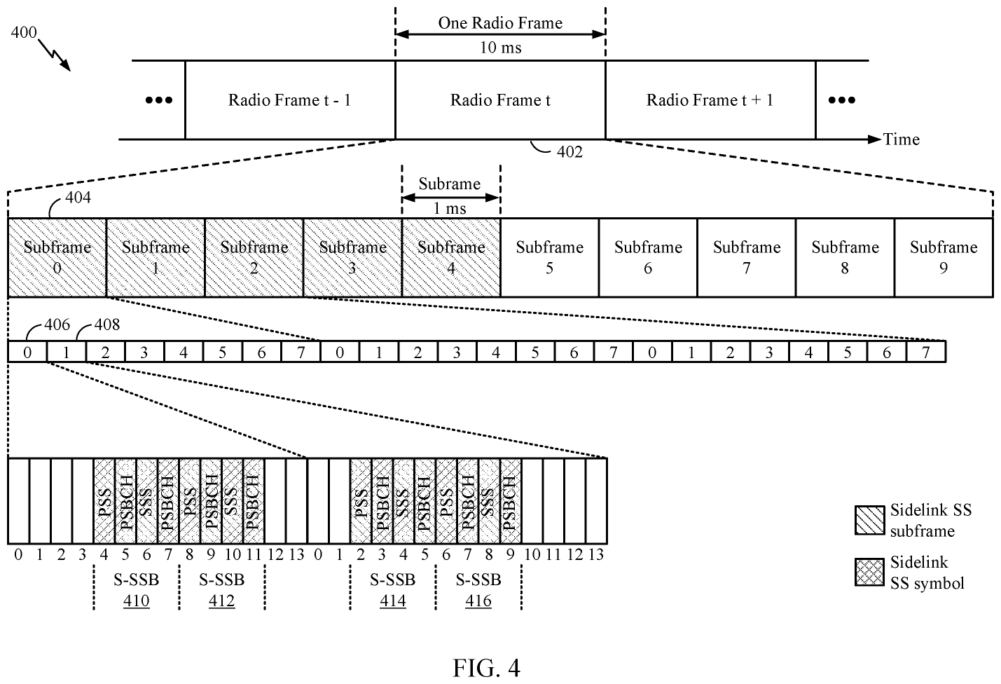

FIG. 4 is a diagram showing an example of a frame format 400. The transmission timeline for each data transmission and reception may be partitioned into units of radio frames 402. In NR, the basic transmission time interval (TTI) may be referred to as a slot. In NR, a subframe may contain a variable number of slots (e.g., 1, 2, 4, 8, 16, . . . , N slots) depending on the subcarrier spacing (SCS). NR may support a base SCS of 15 kHz and other SCS may be defined with respect to the base SCS (e.g., 30 kHz, 60 kHz, 120 kHz, 240 kHz, etc.). In the example shown in FIG. 4, the SCS is 120 kHz. As shown in FIG. 4, the subframe 404 (subframe 0) contains 8 slots (slots 0, 1, . . . , 7) with a 0.125 ms duration. The symbol and slot lengths scale with the subcarrier spacing. Each slot may include a variable number of symbol (e.g., OFDM symbols) periods (e.g., 7 or 14 symbols) depending on the SCS. For the 120 kHz SCS shown in FIG. 4, each of the slot 406 (slot 0) and slot 408 (slot 1) includes 14 symbol periods (slots with indices 0, 1, . . . , 13) with a 0.25 ms duration.

In sidelink, a sidelink synchronization signal block (S-SSB), referred to as the SS block or SSB, is transmitted. The SSB may include a primary SS (PSS), a secondary SS (SSS), and/or a two-symbol physical sidelink broadcast channel (PSBCH). In some examples, the SSB can be transmitted up to sixty-four times with up to sixty-four different beam directions. The up to sixty-four transmissions of the SSB are referred to as the SS burst set. SSBs in an SS burst set may be transmitted in the same frequency region, while SSBs in different SS bursts sets can be transmitted in different frequency regions.

In the example shown in FIG. 4, in the subframe 404, SSB is transmitted in each of the slots (slots 0, 1, . . . , 7). In the example shown in FIG. 4, in the slot 406 (slot 0), an SSB 410 is transmitted in the symbols 4, 5, 6, 7 and an SSB 412 is transmitted in the symbols 8, 9, 10, 11, and in the slot 408 (slot 1), an SSB 414 is transmitted in the symbols 2, 3, 4, 5 and an SSB 416 is transmitted in the symbols 6, 7, 8, 9, and so on. The SSB may include a primary SS (PSS), a secondary (SSS), and a two symbol physical sidelink broadcast channel (PSBCH). The PSS and SSS may be used by UEs to establish sidelink communication (e.g., transmission and/or reception of data and/or control channels). The PSS may provide half-frame timing, the SS may provide cyclic prefix (CP) length and frame timing. The PBSCH carries some basic system information, such as system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), and other system information (OSI) can be transmitted on a physical sidelink shared channel (PSSCH) in certain subframes.

Cellular vehicle to everything (CV2X) communications, such as in NR or LTE, are generally synchronous systems in the sense that transmissions are generally aligned in terms of the time and frequency resources illustrated in FIG. 4. The allocation of frames, subframes, slots, etc. are provisioned for by network protocols and rules that apply to wireless communications in the licensed spectrum. For example, LTE-CV2X and NR-CV2X follow similar principles for establishing time synchronization when operating in a licensed spectrum, which include: (i) using global navigation satellite system (GNSS) as a common time reference (e.g., current coordinated universal time (UTC)), from which a UE derives frame and slot boundaries; and (ii) using an in-band signaling method, by which transmissions originating from both UEs and BSs are scheduled to avoid collision.

However, due to scarcity (e.g., over-crowding) in the licensed spectrum, certain aspects of wireless communication (e.g., CV2X communications) may not operate exclusively in the licensed spectrum. As such, it is possible that CV2X communications may operate in bands of the unlicensed spectrum. Thus, in some examples, GNSS-based synchronization between CV2X devices (e.g., UEs and/or BSs) may be applied in the unlicensed spectrum. In certain aspects, GNSS-based synchronization between CV2X devices may be achieved without signaling overhead (e.g., without synchronization signaling). However, if GNSS-based synchronization is not available or is undesirable due to, for example, reliability issues, it may be preferable that synchronization between CV2X devices is established via periodic, in-band broadcast signaling of synchronization signals.

However, at present, there is no such in-band signaling procedure for CV2X operations in an unlicensed spectrum. Thus, a procedure applicable to both LTE and NR for establishing synchronization between CV2X devices operating in an unlicensed spectrum is desirable.

### Example Techniques for Device Synchronization in Unlicensed Bands

Aspects of the present disclosure provide for synchronization between wireless communication devices, such as CV2X devices in an unlicensed spectrum, and such as without GNSS assistance. In certain aspects, these techniques allow one or more devices to transmit synchronization signals while reducing or eliminating signal loss due to interference from other signals originating from non-CV2X devices using the same spectrum. In certain aspects, these techniques use, for example, listen-before-talk (LBT) channel sensing mechanisms that provide for an approach aligned with regulations for fair use of an unlicensed spectrum, and without having a negative impact on transmissions from other devices. The LBT channel sensing, as described below, is configured to first identify whether a channel is idle before transmitting synchronization signals. This reduces or eliminates signal loss due to signal interference or collision on the same band. In certain aspects, multiple synchronization signals and partial synchronization signals may be transmitted during a window of time for communication of synchronizations signals, which increases the chances of detection of the signals by a receiver, and results in more effective transmission diversity when two or more CV2X devices are transmitting the same synchronization signals at the same time.

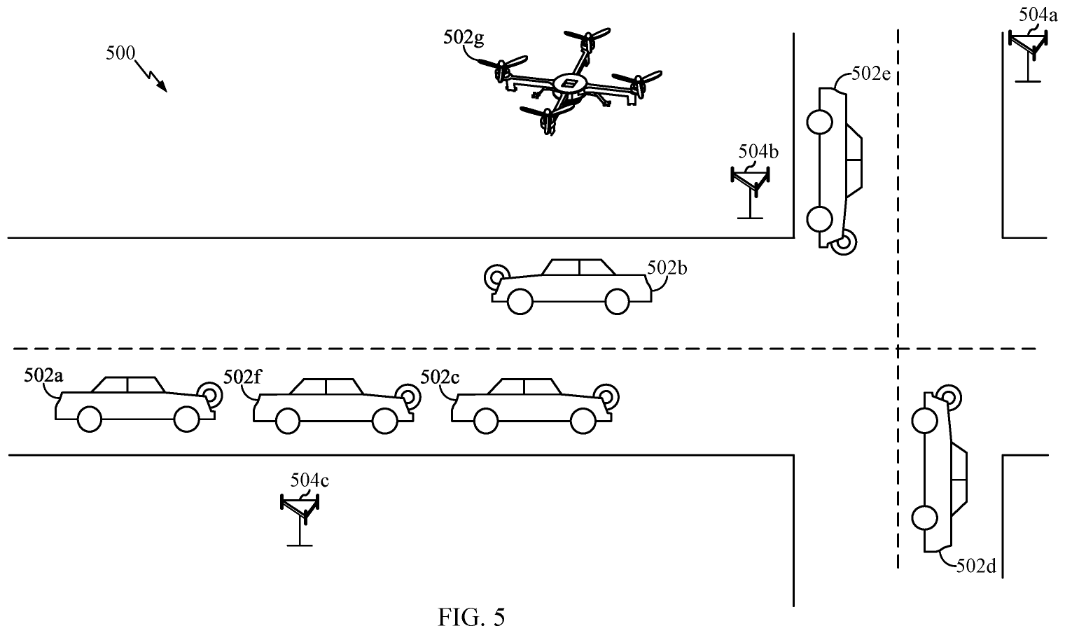

FIG. 5 is a schematic diagram illustrating an example network 500 of multiple CV2X devices operating in an unlicensed spectrum. In the illustrated example, seven CV2X devices (e.g., a first CV2X device 502a, a second CV2X device 502b, a third CV2X device 502c, a fourth CV2X device 502d, a fifth CV2X device 502e, a sixth CV2X device 502f, and a seventh CV2X device 502g)—collectively referred to as CV2X devices 502) may operate in an unlicensed spectrum with other non-CV2X devices (e.g., non-CV2X devices 504a-c—collectively referred to as non-CV2X devices 504). In some examples, the first CV2X device 502a, the sixth CV2X device 502f, and the third CV2X device 502c may be part of a fleet. Although the example provided is illustrative of six automotive CV2X devices in a traffic setting and a drone or other aerial vehicle CV2X device, it can be appreciated that CV2X devices and environments may extend beyond these, and include other wireless communication devices and environments. For example, the CV2X devices 502 may include UEs (e.g., UE 120 of FIG. 1) and/or road-side units (RSUs) operated by a highway authority, and may be devices implemented on motorcycles or carried by users (e.g., pedestrian, bicyclist, etc.), or may be implemented on another aerial vehicle such as a helicopter.

The CV2X devices 502 may include UEs (e.g., UE 120 of FIG. 1), and may be devices implemented on motorcycles or carried by users (e.g., pedestrian, bicyclist, etc.), or implemented as a roadside unit. Here, as will be described in further detail below, a subset of CV2X devices (e.g., first CV2X device 502a) may perform the LBT procedure for a given CV2X window.

In certain aspects, if a plurality of CV2X devices 502 are all time-synchronized, those devices can implement a common time-frequency communication structure in an unlicensed band. In one example, time synchronization can be established based on global navigation satellite system (GNSS) signals (i.e., all CV2X devices 502 use the same GNSS time reference for mapping to facilitate a slot structure for communication). Alternatively, if GNSS is not available, time synchronization can be achieved via signaling means using internal clocks of the CV2X devices 502, and/or by possibly following the same concepts and principles as a channel access procedure.

FIG. 6 is a block diagram illustrating an example of sidelink synchronization signal (e.g., sidelink synchronization signal block (S-SSB)) transmissions in a frequency channel, such as an unlicensed band. In this example, a CV2X device (e.g., CV2X device 502a of FIG. 5) may be configured to transmit synchronization signals (e.g., synchronization signals 606a-606c, collectively referred to as synchronization signals 606) during a time interval 604 (e.g., slot) of multiple time intervals within a window (e.g., windows 602a-602c, collectively referred to as windows 602) of time. The synchronization signals 606 may be used by other CV2X devices 502 to synchronize with the timing of the CV2X device 502a transmitting the synchronization signals 606. The CV2X device 502a transmitting the synchronization signals may determine synchronization timing using GNSS as a common time reference, generate its own time reference, etc.

As shown, each window of time 602 includes four slots numbered 1 through 4. It is appreciated, however, that the number of slots recited throughout the description are examples, and may be changed to include fewer or more slots depending on a size of the window 602, numerology, frequency channel, or any other suitable metric. Each window 602 may occur periodically, as defined by an indication (e.g., a syncOffsetIndicator, or any other suitable indicator). An syncOffsetIndicator may define an offset from a start of a frame from which a window 602 begins, a periodic interval of the window 602 (e.g., every 160 ms or less), a transmission time interval (TTI) of the window 602, etc. In some examples, a CV2X device 502a is configured with one or more syncOffsetIndicators. In some examples, the CV2X device 502a is configured by another device (e.g., another CV2X device, or a BS 110a and/or CN 132) with the one or more syncOffsetIndicators via radio resource control (RRC) signaling.

In certain aspects, the CV2X device 502a may be configured with a plurality of syncOffsetIndicators, with each syncOffsetIndicator corresponding to a different offset, periodic interval, and/or TTI relative to another of the plurality of syncOffsetIndicators. Accordingly, the start, period, and/or duration of each window 602 associated with a syncOffsetIndicator may be different relative to other syncOffsetIndicators. However, in some examples, each window 602 is separate from another window (e.g., each window associated with a syncOffsetIndicator may not overlap in time). For example, a window 602 associated with a first syncOffsetIndicator may not overlap in time with another window of a second syncOffsetIndicator. Accordingly, a synchronization signal transmitted by a first CV2X device within a first window associated with a first syncOffsetIndicator will not collide with another synchronization signal transmitted by a second CV2X device within a second window associated with a second syncOffsetIndicator. As shown in FIG. 6, syncOffsetIndicator-1 608a defines the start of the first window 602a, and each window 602 that occurs periodically thereafter. Further, syncOffsetIndicator-2 608b defines the start of another window of another set of periodic windows (not shown). Thus, the other window starts after the first window 602a and the two windows do not overlap.

In certain aspects, a CV2X device 502a selects, or is configured to use an syncOffsetIndicator associated with a window 602 having a duration long enough to provide the CV2X device 502a with a high probability of having a free time interval 604 over which to transmit a synchronization signal 606, and/or small enough so that time intervals 604 are left available for non-CV2X devices 504 to communicate. That is, a CV2X device 502a may select or be configured to use a window 602 based on traffic load conditions (e.g., for CV2X and/or non-CV2X networks) as measured by a device (e.g., the CV2X device 502a, a road side unit, or a BS 110a). Measured traffic load conditions may include a channel busy ratio (CBR), data traffic overhead (DTO), and any other suitable metric for measuring and indicating traffic load conditions. In some examples, the window 602 may be used only for transmitting synchronization signals for synchronizing CV2X devices 502. Thus, the CV2X device 502a may also be configured to use a syncOffsetIndicator associated with a window 602 that is small enough to prevent the CV2X device 502a and any other CV2X devices 502 from transmitting data over the window 602, but long enough to transmit a synchronization signal. This provides the CV2X device 502a with the ability to determine appropriate time window lengths, periodicity, numerology, etc. based on environmental conditions that allow other non-CV2X devices 504 an appropriate amount of time for non-CV2X communications over the same frequency channel.

Before each window 602, the CV2X device 502a may perform listen-before-talk (LBT) 610 channel sensing function for “listening” or sensing other signals that may interfere with transmission of a synchronization signal by the CV2X device 502a. The LBT 610 may last for any suitable duration, for example, 25 us. As shown, the CV2X device 502a performs a first LBT 610a immediately prior to the first slot of a first window 602a. Here, the CV2X device 502a senses interference over the frequency channel for the entire duration of the first LBT 610a. Due to the interference, the CV2X device 502a refrains from transmitting a synchronization signal in the first slot. Due to the interference detected in the first slot, the CV2X device 502a performs a second LBT 610b during the first slot and immediately prior to a second slot of the first window 602a. If interference is again detected during the entire duration of the second LBT 610b, the CV2X device 502a performs a third LBT 610c during the second slot and immediately prior to a third slot of the first window 602a. The CV2X device 502a may perform LBT for each slot, in chronological order, in the first window 602a until interference is not sensed. Accordingly, a fourth LBT 610d is performed during a third slot of the first window 602a and no interference is detected on the frequency channel. If no interference is sensed immediately prior to a fourth slot of the first window 602a, the CV2X device 502a transmits a first synchronization signal 606a in the fourth slot.

Thus, for each window 602, a CV2X device 502a may perform LBT 610 to sense channel interference immediately prior to one or more of a plurality of slots within the window 602. In certain aspects, after the CV2X device 502a transmits a synchronization signal in a slot, the CV2X device 502a may not perform any additional LBT 610 for the window 602 containing that slot even if there are additional slots in the window and no interference on the frequency channel. As such, once the CV2X device 502a has transmitted a synchronization signal during a window 602, the CV2X device 502a may refrain from transmitting additional synchronization signals in the remaining slots of the same window 602. If interference is sensed during each of the LBTs 610 performed in a window 602, the CV2X device 502a may refrain from transmitting a synchronization signal during that window 602.

For example, during a second window 602b, the CV2X device 502a may perform a fifth LBT 610e immediately prior to a first slot of the second window 602b. In this example, because the CV2X device 502a does not sense interference on the frequency band, the CV2X device 502a may transmit a second synchronization signal 606b during the first slot of the second window 602b. During a third window 602c, the CV2X device 502a may perform a sixth LBT 610f immediately prior to a first slot of the third window 602c. In this example, because the CV2X device 502a senses interference on the frequency band, the CV2X device 502a may refrain from transmitting a synchronization signal 606. The CV2X device 502a may then perform a seventh LBT 610g immediately prior to a second slot of the third window. If the CV2X device 502a does not detect any interference on the frequency band during the seventh LBT, the CV2X device 502a may then transmit a third synchronization signal 606c during the second slot of the third window 602c.

In some examples, a determination of whether or not the frequency channel contains interference is based on an amount of power associated with one or more interfering signals measured on the frequency channel during the LBT 610. For example, if the amount of power measured is greater than a threshold value, then the CV2X device 502a may determine there is interference over the frequency channel and may refrain from transmitting a synchronization signal 606. On the other hand, if the amount of power measured is less than a threshold value, then the CV2X device 502a may determine there is no interference over the frequency channel and may proceed to transmit a synchronization signal 606 over the next slot.

In some examples, the channel is a sidelink channel in an unlicensed spectrum, and the sidelink channel is used for vehicle to everything communication. In some examples, the CV2X device 502a is configured to transmit a synchronization signal 606 that includes an indication of one or more of a slot number and a frame number corresponding to the slot and frame over which the synchronization signal 606 is transmitted. In this way, another CV2X device 502a receiving the synchronization signal 606 can determine frame level and slot level synchronization with the transmitting CV2X device 502a.

While the example of FIG. 6 illustrates transmission of synchronization signals 606 during one slot (e.g., first available slot) in each window, it is appreciated that multiple slots in a single window may be used for transmitting synchronization signals, as is described below. In particular, in certain aspects, once interference is not found prior to a slot of a window 602, a synchronization signal 606 may be transmitted in the slot and in one or more (e.g., all or a fixed number, etc.) remaining slots (if any) in chronological order.

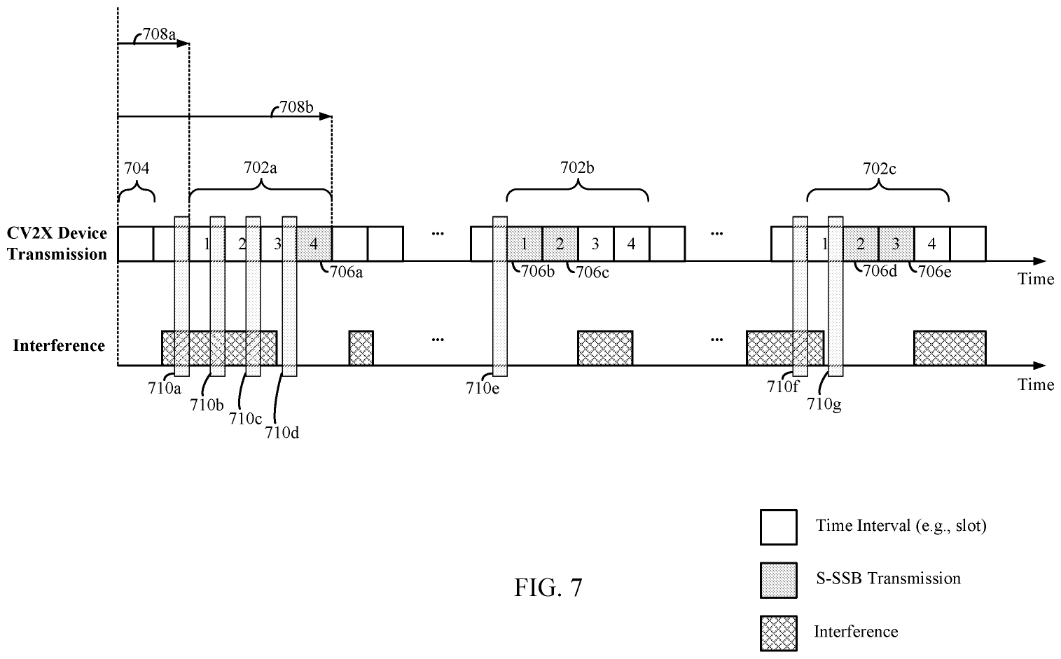

FIG. 7 is a block diagram illustrating an example of sidelink synchronization signal (e.g., sidelink synchronization signal block (S-SSB)) transmissions in a frequency channel, such as an unlicensed band. In this example, a CV2X device (e.g., CV2X device 502a of FIG. 5) may be configured to transmit multiple synchronization signals (e.g., synchronization signals 706a-706e, collectively referred to as synchronization signals 706) during multiple time intervals 704 (e.g., slot) within a window (e.g., windows 702a-702c, collectively referred to as windows 702) of time. For example, when no interference is found during LBT 710 performed prior to a slot, the CV2X device 502a may transmit a synchronization signal over that slot, as well as over one or more subsequent slots in the window. As shown in FIG. 7, syncOffsetIndicator-1 708a defines the start of the first window 702a, and each window 702 that occurs periodically thereafter. Further, syncOffsetIndicator-2 708b defines the start of another window of another set of periodic windows (not shown). Thus, the other window starts after the first window 702a and the first window 702a is separate from the other window (e.g., the two windows do not overlap).

FIG. 7 includes three windows 702, each having four slots 704. Prior to the beginning of a first window 702a, the CV2X device 502a performs a first LBT 710a and senses interference. Similarly, the CV2X device 502a senses interference when it performs a second LBT 710b prior to a second slot, and a third LBT 710c prior to a third slot. However, when the CV2X device 502a performs LBT 710d prior to a fourth slot, no interference is detected. Accordingly, the CV2X device 502a transmits a synchronization signal 706a during the fourth slot.

In the example shown, the CV2X device 502a also performs a fifth LBT 710e prior to a first slot in a second window 702b. If no interference is sensed immediately prior to the first slot, the CV2X device 502a transmits a second synchronization signal 706b in the first slot. Further, in this example, when no interference is sensed in a given slot, the CV2X device 502a transmits a synchronization signal 706 in one or more additional slots (in this example one additional slot) in chronological order subsequent to the given slot when there are remaining slots in the window. Accordingly, the CV2X device 502a transmits a third synchronization signal 706c in the second slot of the second window 702b.

In this example, the CV2X device 502a performs a sixth LBT 710f interference prior to a first slot of a third window 702c, but due to interference on the frequency band, refrains from transmitting a synchronization signal 706. The CV2X device 502a then performs a seventh LBT 710g prior to a second slot, and because no interference is sensed, the CV2X device 502a transmits a fourth synchronization signal 706d during the second slot, as well as a fifth synchronization signal 706e over a third slot of the third window 702c.

In certain aspects, CV2X devices 502 that are all synchronized with each other, but are out of network coverage with no available GNSS, may transmit the same synchronization signal 706 at the same time when all of the other CV2X devices transmit the synchronization signal 706 (e.g., at the same subframe or slot corresponding to a same offset indicator value). If the same synchronization signal 706 is transmitted by each of the CV2X devices 502 at the same time, this results in an effective increase of the received power of the synchronization signal 706 for a particular time interval, which increases the geographic region over which the synchronization signal 706 can be detected relative to a transmission of a synchronization signal 706 from only a single CV2X device. It should be noted, however, that the CV2X devices 502 may use the same techniques to synchronize with other CV2X devices when the CV2X devices 502 are within network coverage and/or have GNSS available. For example, the CV2X devices may synchronize with one or more other CV2X devices using a common synchronization source, based on the synchronization signals transmitted by a synchronization reference device (e.g., CV2X device 502a).

Referring back to FIG. 1, a first UE 120a and a second UE 120c may be transmitting the same synchronization signal 706 at the same time. Due to the superposition of their signaling, the synchronization signal 706 is received by a third UE 120b with increased power relative to a synchronization signal 706 transmission from only one of the first UE 120a or the second UE 120c. Of course, in this example, it is assumed that the first UE 120a and the second UE 120c have already established synchronization of communication, possibly by receiving synchronization signaling from another device (e.g., BS 110a) out of range of the third UE 120b.

It should be noted that this power gain is of significant importance in an unlicensed spectrum because it will help reduce signal loss of a synchronization signal 706 due to local interference. That is, the power gain may increase the probability of detection of the synchronization signal 706 by another CV2X device 502 even if the other CV2X device 502 experiences interference at its location. Thus, in some examples, a CV2X device 502a that intends to transmit a synchronization signal may perform LBT channel sensing over multiple, contiguous slots 704 of a window 702.

As described above with respect to FIGS. 6 and 7, if a CV2X device 502 senses that the frequency channel is idle for an LBT duration that occurs immediately prior the start of a slot, the CV2X device 502 may transmit a synchronization signal over that slot. However, in certain aspects, if a CV2X device 502 senses that the frequency channel is idle during an LBT duration that occurs within a slot, the CV2X device 502 may transmit a partial synchronization signal over the remainder of that slot. For example, the partial synchronization signal may be transmitted in any remaining whole OFDM symbols of the slot or a next symbol of a subsequent slot.

In certain aspects, while performing LBT within a slot, a CV2X device 502 may sense that a frequency channel becomes idle during the slot, but there may not be any whole OFDM symbols remaining within the slot when the determination is made. Accordingly, the CV2X device 502 may determine that the next opportunity to start transmitting a signal is during a part of an OFDM symbol. In such a case, the CV2X device 502 may transmit a “dummy” signal (e.g., a randomly generated sequence) during the remaining portion of the partial OFDM symbol to prevent the frequency channel from being captured by another device (e.g., a non-CV2X device 504).

For example, the CV2X device 502 may fill the remaining portion of the partial OFDM symbol by transmitting dummy sequences, followed immediately by transmission of a synchronization signal in a subsequent full slot and/or OFDM symbol. That is, after transmitting the dummy sequences, the CV2X device 502 may transmit over a partial synchronization signal over the next full OFDM symbol of the current slot and a whole synchronization signal over the next full slot. In one example, a CV2X device 502 with 30 kHz subcarrier spacing (SCS) has a slot duration of 0.5 ms, which makes transmission of synchronization signals over two full slots possible if the CV2X device 502 uses a 25 us LBT channel sensing measurement. This allows for up to 1 ms of channel occupancy time (COT) (e.g., an amount of time provided by the window 702 size, or an amount of time remaining in the window 702).

In certain aspects, the CV2X device 502 may increase the LBT duration by the duration of the partial OFDM symbol instead of transmitting a dummy signal to fill the partial OFDM symbol. In certain aspects, the CV2X device 502 may transmit a synchronization signal in a partial slot instead of a dummy signal when the CV2X device 502 sending the synchronization signal is out of network and GNSS. In certain aspects, transmission of a synchronization signal in a partial slot is configured when duration of 2 consecutive (full) slots is within the COT allowed by a LBT duration requirement (e.g., when the channel is sensed idle for 25 us, wherein the 25 us is the required duration of idle time).

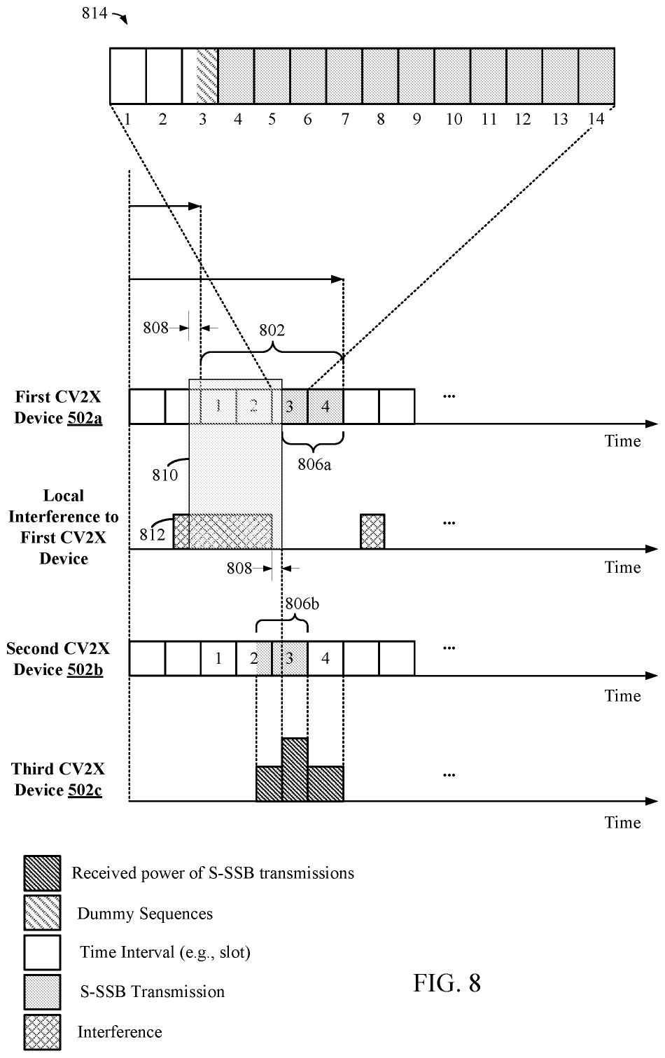

FIG. 8 is a block diagram illustrating example slots, such as for transmitting a synchronization signal (e.g., S-SSB) by multiple CV2X devices 502 in a frequency channel, such as of an unlicensed band. For instance, FIG. 8 illustrates transmission of a first synchronization signal 806a by a first CV2X device 502a, and transmission of a second synchronization signal 806b by a second CV2X device 502b over the same frequency channel and during a same window 802 of time. In some examples, the first synchronization signal 806a is the same signal as the second synchronization signal 806b. Also shown is an indication of synchronization signal power received on the frequency channel by a third device 502c in receiving the synchronization signals 806a and 806b transmitted by the first CV2X device 502a and the second CV2X device 502b.

In this example, the first CV2X device 502a and the second CV2X device 502b may both perform LBT channel sensing prior to transmitting synchronization signals. If the first CV2X device 502a is geographically separated from the second CV2X device 502b, the amount of interference activity on the frequency band sensed at each device may be different. As illustrated, local interference 812 to the first CV2X device 502a begins prior to the window 802 and continues until the end of a second slot of the window 802. The first CV2X device 502a also begins performing LBT 810 prior to the start of the window 802 and immediately detects local interference 812. Here, the first CV2X device 502a performs LBT 810 continuously through the first two slots and into a third slot of the window 802. Here, an LBT duration requirement 808 (e.g., 25 us) may control how far in advance of the beginning of the window 802 the first CV2X device 502a begins the LBT 810. If the local interference 812 ends at the end of the second slot of the window 802, the first CV2X device 502a may continue to perform LBT 810 for the LBT duration requirement 808 beginning once the local interference 812 ends.

In this example, each of the slots include 14 OFDM symbols, wherein the third slot symbols 814 are illustrated in an exploded view. Here, the LBT 810 ends within the third slot of the window 802 leaving only a partial slot remaining. More specifically, the LBT 810 ends halfway through the third OFDM symbol of the third slot symbols 814. Although the first CV2X device 502a may transmit a portion of a synchronization signal that corresponds to the remaining portion of the symbol, in this example the first CV2X device 502a transmits a dummy signal over the remaining portion of the third OFDM symbol to prevent any other nearby devices from transmitting. Upon the start of the fourth OFDM signal, the first CV2X device 502a may begin transmitting a portion of the synchronization signal that corresponds to the remaining portion of the third slot of the window 802, followed by transmission of a synchronization signal over the entire fourth slot. Thus, the synchronization signaling 806a of the first CV2X device 502a includes signaling over a portion of the third slot and the entirety of the fourth slot of the window 802.

As discussed, the second CV2X device 502b may geographically separate from the first CV2X device 502a, and thus, may experience different local interference (not shown). In this example, the second CV2X device 502b, being synchronized (e.g., transmitting synchronization signaling over the same window 802) with the first CV2X device 502a, may begin transmitting synchronization signaling 806b in a portion of the second slot and in the entire third slot. As such, the third CV2X device 502c receives synchronization signaling with relatively more power during a latter portion of the third slot while both the first CV2X device 502a and the second CV2X device 502b are simultaneously transmitting. Thus, the third CV2X device 502c can better detect/decode the synchronization signal as it is more robust to any local interference that the third CV2X device 502c may experience.

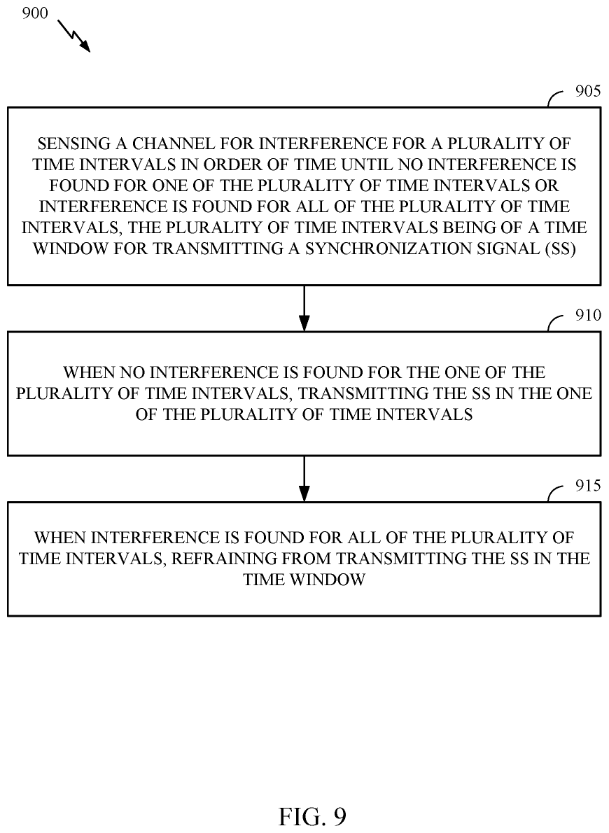

FIG. 9 is a flow diagram illustrating example operations 900 for wireless communication, in accordance with certain aspects of the present disclosure. The operations 900 may be performed, for example, by a BS (e.g., such as the BS 110a in the wireless communication network 100 of FIG. 1) or by a UE or CV2X device (e.g., such as the UE/CV2X device 120a in the wireless communication network 100 of FIG. 1).

Operations 900 may be implemented as software components that are executed and run on one or more processors (e.g., controller/processor 240/280 of FIG. 2). Further, the transmission and reception of signals in operations 900 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 900 may begin, at a first block 905, by sensing a channel for interference for a plurality of time intervals in order of time until no interference is found for one of the plurality of time intervals or interference is found for all of the plurality of time intervals, the plurality of time intervals forming a time window.

In certain aspects, when no interference is found for the one of the plurality of time intervals, operations 900 may proceed, at a second block 910, by transmitting a synchronization signal (SS) in the one of the plurality of time intervals.

In certain aspects, when interference is found for all of the plurality of time intervals, operations 900 may proceed, at a third block 915, by refraining from transmitting the SS in the time window.

In certain aspects, the channel comprises a sidelink in an unlicensed spectrum.

In certain aspects, the sidelink is used for vehicle to everything communication.

In certain aspects, the SS includes a slot number corresponding to the one of the plurality of time intervals and a frame number corresponding to the time window.

In certain aspects, each time interval corresponds to a slot.

In certain aspects, the time window occurs periodically.

In certain aspects, operations 900 further comprise receiving signaling indicating a size of the time window.

In certain aspects, a starting time of the time window is based on one of a plurality of offset indicators, wherein each of the plurality of offset indicators is associated with a different size time window.

In certain aspects, a starting time of the time window is based on one of a plurality of offset indicators, wherein each of the plurality of offset indicators is associated with a different time window, wherein the time window is separate from the different time window.

In certain aspects, the operations 900 further comprise, when no interference is found for the one of the plurality of time intervals, transmitting the SS in one or more of the plurality of time intervals later in time than the one of the plurality of time intervals.

In certain aspects, sensing the channel for interference for a time interval comprises sensing the channel for interference for a time duration prior to a start of the time interval.

In certain aspects, sensing the channel for interference comprises sensing the channel continuously over the time window, wherein interference is found in a first portion of the one of the plurality of time intervals, wherein no interference is found in a second portion of the one of the plurality of time intervals that occurs later in time than the first portion, wherein transmitting the SS in the one of the plurality of time intervals comprises transmitting the SS in the second portion of the one of the plurality of time intervals.

In certain aspects, operations 900 further comprise transmitting the SS in one or more of the plurality of time intervals later in time than the one of the plurality of time intervals.

In certain aspects, the channel is used for communication between a plurality of devices that are out of network coverage.

In certain aspects, the plurality of devices lack synchronization to a global navigation satellite system.

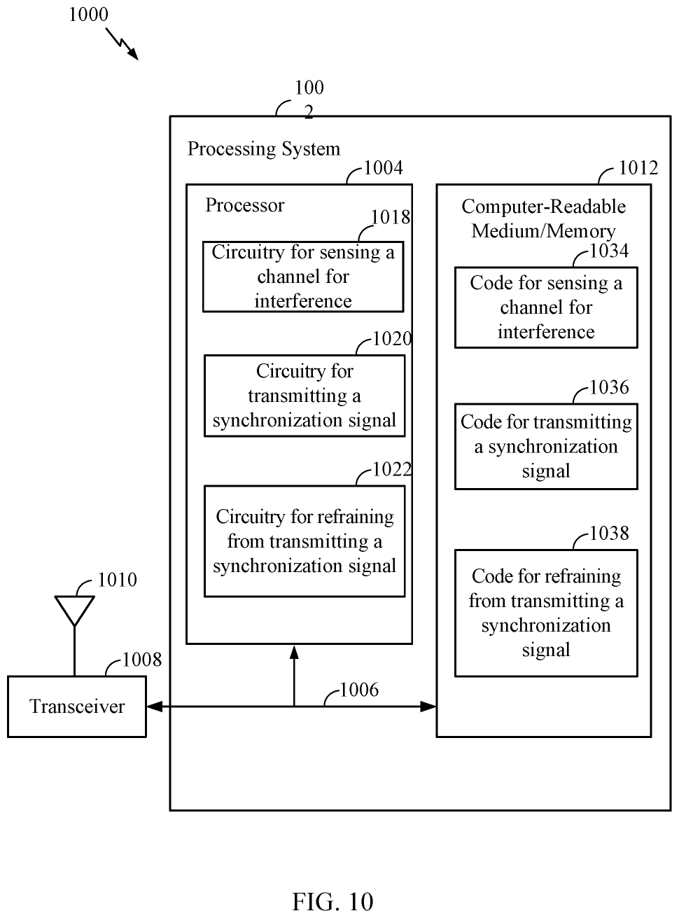

FIG. 10 illustrates a communications device 1000 that may include various components (e.g., corresponding to means-plus-function components) configured to perform operations for the techniques disclosed herein, such as the operations illustrated in FIG. 9. The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 9, or other operations for performing the various techniques discussed herein for performing sidelink communications in unlicensed bands.

In certain aspects, computer-readable medium/memory 1012 stores code 1034 for sensing a channel for interference for a plurality of time intervals in order of time until no interference is found for one of the plurality of time intervals or interference is found for all of the plurality of time intervals, the plurality of time intervals forming a time window.

In certain aspects, computer-readable medium/memory 1012 stores code 1036 for transmitting a synchronization signal (SS) in the one of the plurality of time intervals when no interference is found for the one of the plurality of time intervals.

In certain aspects, computer-readable medium/memory 1012 stores code 1038 for refraining from transmitting the SS in the time window when interference is found for all of the plurality of time intervals.

In certain aspects, the processor 1004 has circuitry configured to implement the code stored in the computer-readable medium/memory 1012. The processor 1004 includes circuitry 1018 for sensing a channel for interference for a plurality of time intervals in order of time until no interference is found for one of the plurality of time intervals or interference is found for all of the plurality of time intervals, the plurality of time intervals forming a time window.

In certain aspects, the processor 1004 includes circuitry 1020 for transmitting a synchronization signal (SS) in the one of the plurality of time intervals when no interference is found for the one of the plurality of time intervals.

In certain aspects, the processor 1004 includes circuitry 1022 for refraining from transmitting the SS in the time window when interference is found for all of the plurality of time intervals.

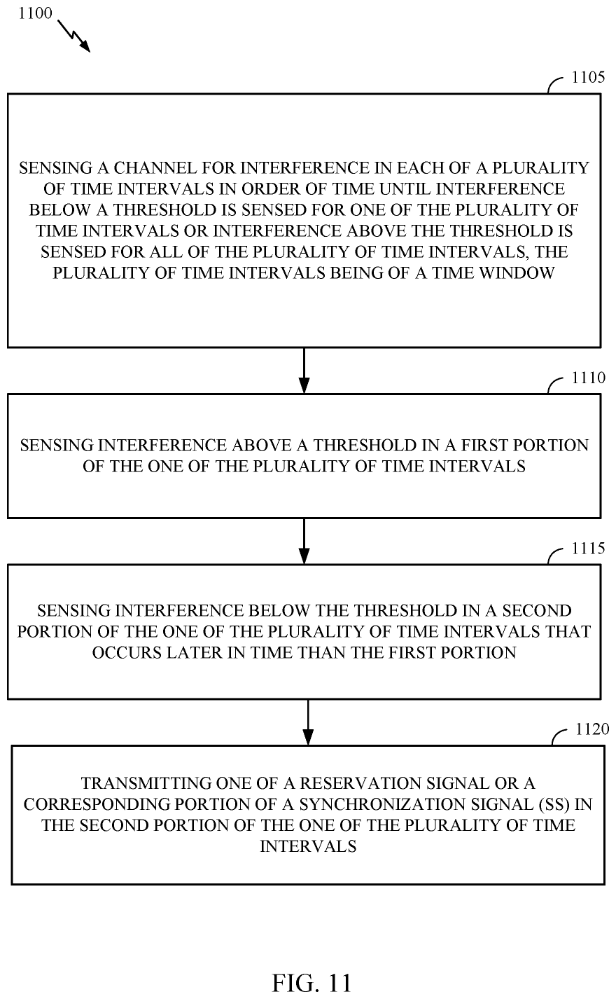

FIG. 11 is a flow diagram illustrating example operations 1100 for wireless communication, in accordance with certain aspects of the present disclosure. The operations 1100 may be performed, for example, by a BS (e.g., such as the BS 110a in the wireless communication network 100 of FIG. 1) or by a UE or CV2X device (e.g., such as the UE/CV2X device 120a in the wireless communication network 100 of FIG. 1).

Operations 1100 may be implemented as software components that are executed and run on one or more processors (e.g., controller/processor 240/280 of FIG. 2). Further, the transmission and reception of signals in operations 1100 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1100 may begin, at a first block 1105, by sensing a channel for interference in each of a plurality of time intervals in order of time until interference below a threshold is sensed for one of the plurality of time intervals or interference above the threshold is sensed for all of the plurality of time intervals, the plurality of time intervals forming a time window.

The operations 1100 may proceed to a second block 1110 by sensing interference to be above a threshold in a first portion of the one of the plurality of time intervals.

The operations 1100 may proceed to a third block 1115 by sensing interference to be below the threshold in a second portion of the one of the plurality of time intervals that occurs later in time than the first portion.

The operations 1100 may proceed to a fourth block 1120 by transmitting one of a reservation signal or a portion of a synchronization signal (SS) corresponding to the second portion in the second portion of the one of the plurality of time intervals.

In certain aspects, each of the plurality of time intervals comprises a plurality of symbols, wherein the second portion of the one of the plurality of time intervals is a portion of a first symbol of the corresponding plurality of symbols, wherein the operations 1100 further comprise transmitting the reservation signal over a remaining portion of the first symbol.

In certain aspects, transmitting the SS in the second portion of the plurality of time intervals comprises transmitting the SS in a second symbol of the corresponding plurality of symbols, the second symbol occurring immediately after the first symbol in time.

In certain aspects, a size of the time window is a function of a number of previous time intervals during which interference above a threshold was sensed.

In certain aspects, a starting time of the time window is based on one of a plurality of offset indicators, wherein each of the plurality of offset indicators is associated with a different size time window.

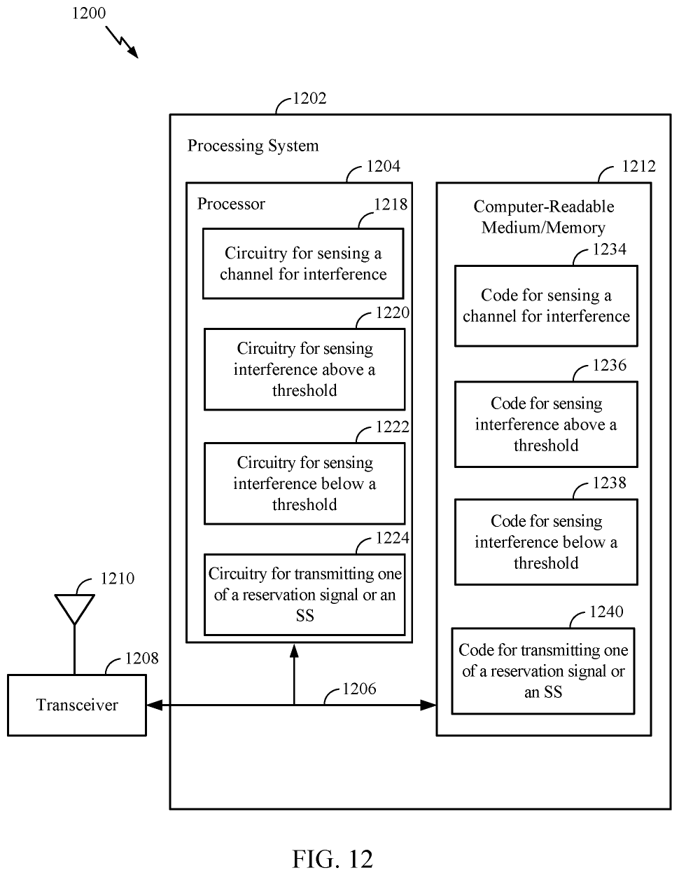

FIG. 12 illustrates a communications device 1200 that may include various components (e.g., corresponding to means-plus-function components) configured to perform operations for the techniques disclosed herein, such as the operations illustrated in FIG. 11. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 11, or other operations for performing the various techniques discussed herein for performing sidelink communications in unlicensed bands.

In certain aspects, computer-readable medium/memory 1212 stores code 1234 for sensing a channel for interference in each of a plurality of time intervals in order of time until interference below a threshold is sensed for one of the plurality of time intervals or interference above the threshold is sensed for all of the plurality of time intervals, the plurality of time intervals forming a time window.

In certain aspects, computer-readable medium/memory 1212 stores code 1236 for sensing interference to be above a threshold in a first portion of the one of the plurality of time intervals.

In certain aspects, computer-readable medium/memory 1212 stores code 1238 for sensing interference to be below the threshold in a second portion of the one of the plurality of time intervals that occurs later in time than the first portion.

In certain aspects, computer-readable medium/memory 1212 stores code 1240 for transmitting one of a reservation signal or a portion of a synchronization signal (SS) corresponding to the second portion in the second portion of the plurality of time intervals.

In certain aspects, the processor 1204 has circuitry configured to implement the code stored in the computer-readable medium/memory 1212. The processor 1204 includes circuitry 1218 for sensing a channel for interference in each of a plurality of time intervals in order of time until interference below a threshold is sensed for one of the plurality of time intervals or interference above the threshold is sensed for all of the plurality of time intervals, the plurality of time intervals forming a time window.

In certain aspects, the processor 1204 includes circuitry 1220 for sensing interference to be above a threshold in a first portion of the one of the plurality of time intervals.

In certain aspects, the processor 1204 includes circuitry 1222 for sensing interference to be below the threshold in a second portion of the one of the plurality of time intervals that occurs later in time than the first portion.

In certain aspects, the processor 1004 includes circuitry 1224 for transmitting one of a reservation signal or a portion of a synchronization signal (SS) corresponding to the second portion in the second portion of the one of the plurality of time intervals.

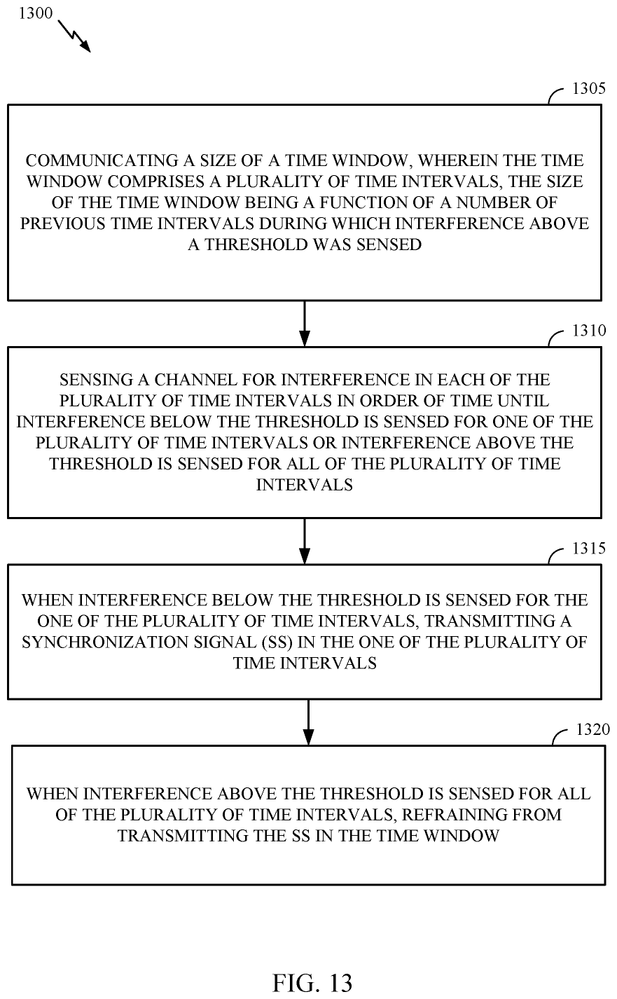

FIG. 13 is a flow diagram illustrating example operations 1300 for wireless communication, in accordance with certain aspects of the present disclosure. The operations 1300 may be performed, for example, by a BS (e.g., such as the BS 110a in the wireless communication network 100 of FIG. 1) or by a UE or CV2X device (e.g., such as the UE/CV2X device 120a in the wireless communication network 100 of FIG. 1).

Operations 1300 may be implemented as software components that are executed and run on one or more processors (e.g., controller/processor 240/280 of FIG. 2). Further, the transmission and reception of signals in operations 1300 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1300 may begin, at a first block 1305, by communicating a size of a time window, wherein the time window comprises a plurality of time intervals, the size of the time window based at least in part on a number of previous time intervals during which interference above a threshold was sensed.

The operations 1300 may proceed to a second block 1310 by sensing a channel for interference in each of the plurality of time intervals in order of time until interference below the threshold is sensed for one of the plurality of time intervals or interference above the threshold is sensed for all of the plurality of time intervals.

The operations 1300 may proceed to a third block 1315 by, when interference below the threshold is sensed for the one of the plurality of time intervals, transmitting a synchronization signal (SS) in the one of the plurality of time intervals.

The operations 1300 may proceed to a fourth block 1320 by, when interference above the threshold is sensed for all of the plurality of time intervals, refraining from transmitting the SS in the time window.

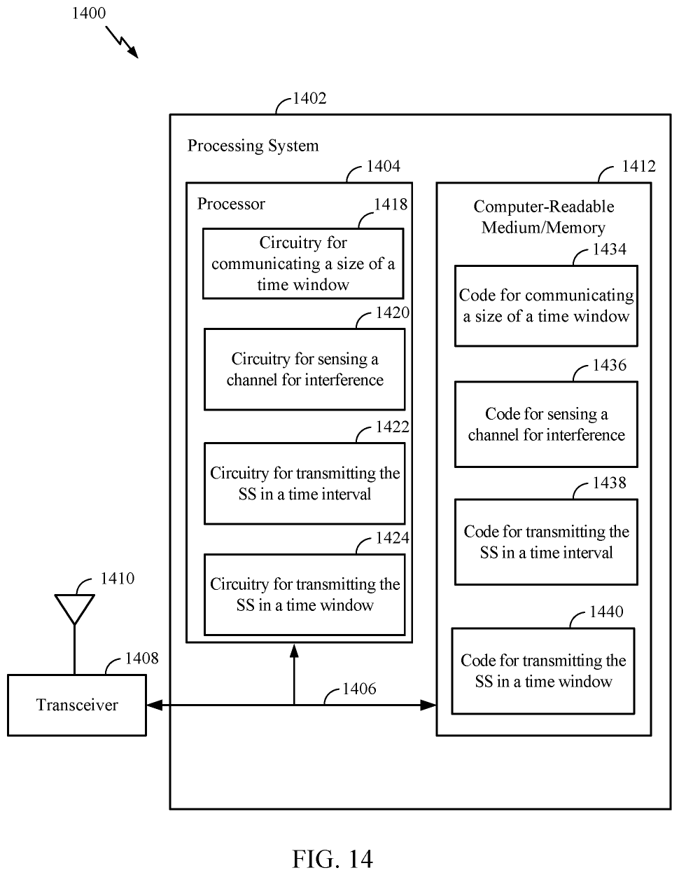

FIG. 14 illustrates a communications device 1400 that may include various components (e.g., corresponding to means-plus-function components) configured to perform operations for the techniques disclosed herein, such as the operations illustrated in FIG. 13. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIG. 13, or other operations for performing the various techniques discussed herein for performing sidelink communications in unlicensed bands.

In certain aspects, computer-readable medium/memory 1412 stores code 1434 for communicating a size of a time window, wherein the time window comprises a plurality of time intervals, the size of the time window based at least in part on a number of previous time intervals during which interference above a threshold was sensed.

In certain aspects, computer-readable medium/memory 1412 stores code 1436 for sensing a channel for interference in each of the plurality of time intervals in order of time until interference below the threshold is sensed for one of the plurality of time intervals or interference above the threshold is sensed for all of the plurality of time intervals.

In certain aspects, computer-readable medium/memory 1412 stores code 1438 for when interference below the threshold is sensed for the one of the plurality of time intervals, transmitting a synchronization signal (SS) in the one of the plurality of time intervals.

In certain aspects, computer-readable medium/memory 1412 stores code 1440 for when interference above the threshold is sensed for all of the plurality of time intervals, refraining from transmitting the SS in the time window.

In certain aspects, the processor 1404 has circuitry configured to implement the code stored in the computer-readable medium/memory 1412. The processor 1404 includes circuitry 1418 for communicating a size of a time window, wherein the time window comprises a plurality of time intervals, the size of the time window based at least in part on a number of previous time intervals during which interference above a threshold was sensed.

In certain aspects, the processor 1404 includes circuitry 1420 for sensing a channel for interference in each of the plurality of time intervals in order of time until interference below the threshold is sensed for one of the plurality of time intervals or interference above the threshold is sensed for all of the plurality of time intervals.

In certain aspects, the processor 1404 includes circuitry 1422 for, when interference below the threshold is sensed for the one of the plurality of time intervals, transmitting a synchronization signal (SS) in the one of the plurality of time intervals.

In certain aspects, the processor 1404 includes circuitry 1424 for, when interference above the threshold is sensed for all of the plurality of time intervals, refraining from transmitting the SS in the time window.

### Example Aspects

Aspect 1: A device for wireless communication, comprising: a memory; and a processor coupled to the memory, wherein the processor and memory are configured to: sense a channel for interference in each of a plurality of time intervals in order of time until interference below a threshold is sensed for one of the plurality of time intervals or interference above the threshold is sensed for all of the plurality of time intervals, the plurality of time intervals forming a time window; sense interference to be above a threshold in a first portion of the one of the plurality of time intervals; sense interference to be below the threshold in a second portion of the one of the plurality of time intervals that occurs later in time than the first portion; and transmit one of a reservation signal or a portion of a synchronization signal (SS) corresponding to the second portion in the second portion of the plurality of time intervals.

Aspect 2: The device of Aspect 1, wherein each of the plurality of time intervals comprises a plurality of symbols, wherein the second portion of the one of the plurality of time intervals is a portion of a first symbol of the corresponding plurality of symbols, and wherein the processor and the memory are further configured to transmit the reservation signal over a remaining portion of the first symbol.

Aspect 3: The device of any of Aspects 1 and 2, wherein the processor and the memory, being configured to transmit the SS in the second portion of the plurality of time intervals, are further configured to transmit the SS in a second symbol of the corresponding plurality of symbols, the second symbol occurring immediately after the first symbol in time.

Aspect 4: The device of any of Aspects 1-3, wherein a size of the time window is a function of a number of previous time intervals during which interference above a threshold was sensed.

Aspect 5: The device of any of Aspects 1-4 wherein the processor and the memory are further configured to receive signaling indicating a size of the time window.

Aspect 6: The device of any of Aspects 1-5, wherein a starting time of the time window is based on one of a plurality of offset indicators, wherein each of the plurality of offset indicators is associated with a different size time window.

Aspect 7: The device of any of Aspects 1-6, wherein a first time window associated with a first offset indicator is separate from a second time window associated with a second offset indicator.

Aspect 8: The device of any of Aspects 1-7, wherein the processor and the memory, being configured to transmit the SS in the second portion of the one of the plurality of time intervals when interference below the threshold is sensed for the one of the plurality of time intervals, are further configured to transmit the SS in one or more of the plurality of time intervals later in time than the one of the plurality of time intervals.

Aspect 9: The device of any of Aspects 1-8, wherein the processor and the memory, being configured to sense the channel for interference for a time interval, are further configured to sense the channel for interference for a time duration prior to a start of the time interval.

Aspect 10: The device of any of Aspects 1-9, wherein the channel comprises a sidelink in an unlicensed spectrum, and wherein the sidelink is used for vehicle to everything communication.

Aspect 11: The device of any of Aspects 1-10, wherein the SS includes a slot number corresponding to the one of the plurality of time intervals and a frame number corresponding to the time window.

Aspect 12: The device of any of Aspects 1-11, wherein each time interval corresponds to a slot.

Aspect 13: The device of any of Aspects 1-12, wherein the time window occurs periodically.

Aspect 14: The device of any of Aspects 1-13, wherein the channel is used for communication between a plurality of devices that are outside of network coverage.

Aspect 15: The device of any of Aspects 1-14, wherein the plurality of devices lack synchronization to a global navigation satellite system.

Aspect 16: A device for wireless communication, comprising: a memory; and a processor coupled to the memory, the processor and the memory configured to: communicate a size of a time window, wherein the time window comprises a plurality of time intervals, the size of the time window based at least in part on a number of previous time intervals during which interference above a threshold was sensed; sense a channel for interference in each of the plurality of time intervals in order of time until interference below the threshold is sensed for one of the plurality of time intervals or interference above the threshold is sensed for all of the plurality of time intervals; when interference below the threshold is sensed for the one of the plurality of time intervals, transmit a synchronization signal (SS) in the one of the plurality of time intervals; and when interference above the threshold is sensed for all of the plurality of time intervals, refrain from transmitting the SS in the time window.

Aspect 17: The device of Aspects 16, wherein a starting time of the time window is based on one of a plurality of offset indicators, wherein each of the plurality of offset indicators is associated with a different size time window.

Aspect 18: The device of any of Aspects 16 and 17, wherein the processor and the memory, being configured to sense the channel for interference, are further configured to sense the channel continuously over the time window, wherein interference above the threshold is sensed in a first portion of the one of the plurality of time intervals, wherein interference below the threshold is sensed in a second portion of the one of the plurality of time intervals that occurs later in time than the first portion; and wherein the processor and the memory, being configured to transmit the SS in the one of the plurality of time intervals, are further configured to transmit the SS in the second portion of the one of the plurality of time intervals.

Aspect 19: The device of any of Aspects 16-18, wherein the processor and the memory are further configured to transmit the SS in one or more of the plurality of time intervals later in time than the one of the plurality of time intervals.

Aspect 20: The device of any of Aspects 16-19, wherein the SS includes a slot number corresponding to the one of the plurality of time intervals and a frame number corresponding to the time window.

Aspect 21: The device of any of Aspects 16-20, wherein the channel is used for communication between a plurality of devices that are out of network coverage.

Aspect 22: The device of any of Aspects 16-21, wherein the plurality of devices lack synchronization to a global navigation satellite system.

Aspect 23: The device of any of Aspects 16-22, wherein the channel comprises a sidelink in an unlicensed spectrum, and wherein the sidelink is used for vehicle to everything communication.

Aspect 24: A method of wireless communication by a device, comprising: sensing a channel for interference in each of a plurality of time intervals in order of time until interference below a threshold is sensed for one of the plurality of time intervals or interference above the threshold is sensed for all of the plurality of time intervals, the plurality of time intervals forming a time window; sensing interference to be above a threshold in a first portion of the one of the plurality of time intervals; sensing interference to be below the threshold in a second portion of the one of the plurality of time intervals that occurs later in time than the first portion; and transmitting one of a reservation signal or a portion of a synchronization signal (SS) corresponding to the second portion in the second portion of the one of the plurality of time intervals.

Aspect 25: The method of Aspect 24, wherein each of the plurality of time intervals comprises a plurality of symbols, wherein the second portion of the one of the plurality of time intervals is a portion of a first symbol of the corresponding plurality of symbols, wherein the method further comprises transmitting the reservation signal over a remaining portion of the first symbol.

Aspect 26: The method of any of Aspects 24 and 25, wherein transmitting the SS in the second portion of the plurality of time intervals comprises transmitting the SS in a second symbol of the corresponding plurality of symbols, the second symbol occurring immediately after the first symbol in time.

Aspect 27: The device of any of Aspects 24-26, wherein a size of the time window is a function of a number of previous time intervals during which interference above a threshold was sensed.

Aspect 28: The device of any of Aspects 24-27, wherein a starting time of the time window is based on one of a plurality of offset indicators, wherein each of the plurality of offset indicators is associated with a different size time window.

Aspect 29: A method of wireless communication by a device, comprising: communicating a size of a time window, wherein the time window comprises a plurality of time intervals, the size of the time window based at least in part on a number of previous time intervals during which interference above a threshold was sensed; sensing a channel for interference in each of the plurality of time intervals in order of time until interference below the threshold is sensed for one of the plurality of time intervals or interference above the threshold is sensed for all of the plurality of time intervals; when interference below the threshold is sensed for the one of the plurality of time intervals, transmitting the SS in the one of the plurality of time intervals; and when interference above the threshold is sensed for all of the plurality of time intervals, refraining from transmitting a synchronization signal (SS) in the time window.

Aspect 30: The method of Aspect 29, wherein a starting time of the time window is based on one of a plurality of offset indicators, wherein each of the plurality of offset indicators is associated with a different size time window.

Aspect 31: A method of wireless communication by a device, comprising: sensing a channel for interference for a plurality of time intervals in order of time until no interference is found for one of the plurality of time intervals or interference is found for all of the plurality of time intervals, the plurality of time intervals forming a time window; when no interference is found for the one of the plurality of time intervals, transmitting a synchronization signal (SS) in the one of the plurality of time intervals; and when interference is found for all of the plurality of time intervals, refraining from transmitting the SS in the time window.

Aspect 32: The method of Aspect 31, wherein the channel comprises a sidelink in an unlicensed spectrum.

Aspect 33: The method of Aspect 32, wherein the sidelink is used for vehicle to everything communication.

Aspect 34: The method of any of Aspects 31-33, wherein the SS includes a slot number corresponding to the one of the plurality of time intervals and a frame number corresponding to the time window.

Aspect 35: The method of any of Aspects 31-34, wherein each time interval corresponds to a slot.

Aspect 36: The method of any of Aspects 31-35, wherein the time window occurs periodically.

Aspect 37: The method of any of Aspects 31-36, further comprising receiving signaling indicating a size of the time window.

Aspect 38: The method of any of Aspects 31-37, wherein a starting time of the time window is based on one of a plurality of offset indicators, wherein each of the plurality of offset indicators is associated with a different size time window.

Aspect 39: The method of any of Aspects 31-38, wherein a starting time of the time window is based on one of a plurality of offset indicators, wherein each of the plurality of offset indicators is associated with a different time window, wherein the time window is separate from the different time window.

Aspect 40: The method of any of Aspects 31-39, further comprising, when no interference is found for the one of the plurality of time intervals, transmitting the SS in one or more of the plurality of time intervals later in time than the one of the plurality of time intervals.

Aspect 41: The method of any of Aspects 31-40, wherein sensing the channel for interference for a time interval comprises sensing the channel for interference for a time duration prior to a start of the time interval.

Aspect 42: The method of any of Aspects 31-41, wherein sensing the channel for interference comprises sensing the channel continuously over the time window, wherein interference is found in a first portion of the one of the plurality of time intervals, wherein no interference is found in a second portion of the one of the plurality of time intervals that occurs later in time than the first portion, wherein transmitting the SS in the one of the plurality of time intervals comprises transmitting the SS in the second portion of the one of the plurality of time intervals.

Aspect 43: The method of Aspect 42, further comprising transmitting the SS in one or more of the plurality of time intervals later in time than the one of the plurality of time intervals.

Aspect 44: The method of Aspect 42 or 43, wherein the channel is used for communication between a plurality of devices that are out of network coverage.

Aspect 45: The method of Aspect 44, wherein the plurality of devices lack synchronization to a global navigation satellite system.

Aspect 46: A user equipment (UE) for wireless communication, comprising a memory and one or more processors for performing the method of any of Aspects 31-45.

Aspect 47: A user equipment (UE) comprising: one or more means for performing the method of any of Aspects 1-45.

Aspect 48: A non-transitory computer-readable storage medium having instructions stored thereon for performing the method of any of Aspects 1-45 for wireless communication by a user equipment (UE).

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. CDMA2000 covers Interim Standards (e.g., IS-2000, IS-95 and IS-856). A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise a non-transitory computer-readable medium (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 9, 11, and 13.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A device for wireless communication, comprising:
a memory; and
a processor coupled to the memory, the processor and memory are configured to:
sense a channel for interference in each of a plurality of time intervals in order of time until interference below a threshold is sensed for one of the plurality of time intervals or interference above the threshold is sensed for all of the plurality of time intervals, the plurality of time intervals forming a time window;
sense interference to be above a threshold in a first portion of the one of the plurality of time intervals;
sense interference to be below the threshold in a second portion of the one of the plurality of time intervals that occurs later in time than the first portion; and
transmit one of a reservation signal or a portion of a synchronization signal (SS) corresponding to the second portion in the second portion of the one of the plurality of time intervals.

2. The device of claim 1, wherein each of the plurality of time intervals comprises a plurality of symbols, wherein the second portion of the one of the plurality of time intervals is a portion of a first symbol of the corresponding plurality of symbols, and wherein the processor and the memory are further configured to transmit the reservation signal over a remaining portion of the first symbol.

3. The device of claim 2, wherein the processor and the memory, being configured to transmit the SS in the second portion of the plurality of time intervals, are further configured to transmit the SS in a second symbol of the corresponding plurality of symbols, the second symbol occurring immediately after the first symbol in time.

4. The device of claim 1, wherein a size of the time window is a function of a number of previous time intervals during which interference above a threshold was sensed.

5. The device of claim 1, wherein the processor and the memory are further configured to receive signaling indicating a size of the time window.

6. The device of claim 1, wherein a starting time of the time window is based on one of a plurality of offset indicators, wherein each of the plurality of offset indicators is associated with a different size time window.

7. The device of claim 6, wherein a first time window associated with a first offset indicator is separate from a second time window associated with a second offset indicator.

8. The device of claim 1, wherein the processor and the memory, being configured to transmit the SS in the second portion of the one of the plurality of time intervals when interference below the threshold is sensed for the one of the plurality of time intervals, are further configured to transmit the SS in one or more of the plurality of time intervals later in time than the one of the plurality of time intervals.

9. The device of claim 1, wherein the processor and the memory, being configured to sense the channel for interference for a time interval, are further configured to sense the channel for interference for a time duration prior to a start of the time interval.

10. The device of claim 1, wherein the channel comprises a sidelink in an unlicensed spectrum, and wherein the sidelink is used for vehicle to everything communication.

11. The device of claim 1, wherein the SS includes a slot number corresponding to the one of the plurality of time intervals and a frame number corresponding to the time window.

12. The device of claim 1, wherein each time interval corresponds to a slot.

13. The device of claim 1, wherein the time window occurs periodically.

14. The device of claim 1, wherein the channel is used for communication between a plurality of devices that are outside of network coverage.

15. The device of claim 14, wherein the plurality of devices lack synchronization to a global navigation satellite system.

16. A device for wireless communication, comprising:
a memory; and
a processor coupled to the memory, the processor and the memory configured to:
communicate a size of a time window, wherein the time window comprises a plurality of time intervals, the size of the time window based at least in part on a number of previous time intervals during which interference above a threshold was sensed;
sense a channel for interference in each of the plurality of time intervals in order of time until interference below the threshold is sensed for one of the plurality of time intervals or interference above the threshold is sensed for all of the plurality of time intervals;
when interference below the threshold is sensed for the one of the plurality of time intervals, transmit a synchronization signal (SS) in the one of the plurality of time intervals; and
when interference above the threshold is sensed for all of the plurality of time intervals, refrain from transmitting the SS in the time window.

17. The device of claim 16, wherein a starting time of the time window is based on one of a plurality of offset indicators, wherein each of the plurality of offset indicators is associated with a different size time window.

18. The device of claim 16, wherein the processor and the memory, being configured to sense the channel for interference, are further configured to sense the channel continuously over the time window, wherein interference above the threshold is sensed in a first portion of the one of the plurality of time intervals, wherein interference below the threshold is sensed in a second portion of the one of the plurality of time intervals that occurs later in time than the first portion; and
wherein the processor and the memory, being configured to transmit the SS in the one of the plurality of time intervals, are further configured to transmit the SS in the second portion of the one of the plurality of time intervals.

19. The device of claim 18, wherein the processor and the memory are further configured to transmit the SS in one or more of the plurality of time intervals later in time than the one of the plurality of time intervals.

20. The device of claim 16, wherein the SS includes a slot number corresponding to the one of the plurality of time intervals and a frame number corresponding to the time window.

21. The device of claim 16, wherein the channel is used for communication between a plurality of devices that are out of network coverage.

22. The device of claim 21, wherein the plurality of devices lack synchronization to a global navigation satellite system.

23. The device of claim 16, wherein the channel comprises a sidelink in an unlicensed spectrum, and wherein the sidelink is used for vehicle to everything communication.

24. A method of wireless communication by a device, comprising:
sensing a channel for interference in each of a plurality of time intervals in order of time until interference below a threshold is sensed for one of the plurality of time intervals or interference above the threshold is sensed for all of the plurality of time intervals, the plurality of time intervals being of a time window;
sensing interference to be above a threshold in a first portion of the one of the plurality of time intervals;
sensing interference to be below the threshold in a second portion of the one of the plurality of time intervals that occurs later in time than the first portion; and
transmitting one of a reservation signal or a corresponding portion of a synchronization signal (SS) in the second portion of the one of the plurality of time intervals.

25. The method of claim 24, wherein each of the plurality of time intervals comprises a plurality of symbols, wherein the second portion of the one of the plurality of time intervals is a portion of a first symbol of the corresponding plurality of symbols, wherein the method further comprises transmitting the reservation signal over a remaining portion of the first symbol.

26. The method of claim 25, wherein transmitting the SS in the second portion of the plurality of time intervals comprises transmitting the SS in a second symbol of the corresponding plurality of symbols, the second symbol occurring immediately after the first symbol in time.

27. The method of claim 24, wherein a size of the time window is a function of a number of previous time intervals during which interference above a threshold was sensed.

28. The method of claim 24, wherein a starting time of the time window is based on one of a plurality of offset indicators, wherein each of the plurality of offset indicators is associated with a different size time window.

29. A method of wireless communication by a device, comprising:
communicating a size of a time window, wherein the time window comprises a plurality of time intervals, the size of the time window based at least in part on a number of previous time intervals during which interference above a threshold was sensed;
sensing a channel for interference in each of the plurality of time intervals in order of time until interference below the threshold is sensed for one of the plurality of time intervals or interference above the threshold is sensed for all of the plurality of time intervals;
when interference below the threshold is sensed for the one of the plurality of time intervals, transmitting a synchronization signal (SS) in the one of the plurality of time intervals in the one of the plurality of time intervals; and
when interference above the threshold is sensed for all of the plurality of time intervals, refraining from transmitting the SS in the time window.

30. The method of claim 29, wherein a starting time of the time window is based on one of a plurality of offset indicators, wherein each of the plurality of offset indicators is associated with a different size time window.
